(19) United States
(12) Patent Application Publication
(10) Pub. No.: US 2025/0220641 A1
(43) Pub. Date: Jul. 3, 2025

(54) Data Transmission Method and Apparatus

(71) Applicant: Huawei Technologies Co., Ltd., Shenzhen (CN)

(72) Inventors: Xiuqiang Xu, Shanghai (CN); Lei Wang, Shanghai (CN); Yan Chen, Ottawa (CA)

(21) Appl. No.: 19/084,229

(22) Filed: Mar. 19, 2025

Related U.S. Application Data
(63) Continuation of application No. PCT/CN2022/119658, filed on Sep. 19, 2022.

(51) Int. Cl. H04W 72/044; H04W 72/1268

(52) U.S. Cl. CPC H04W 72/044; H04W 72/1268

(57) ABSTRACT

A data transmission method includes a first terminal apparatus that obtains a first time-frequency resource. The first time-frequency resource is used by a second terminal apparatus to transmit first uplink data. The first time-frequency resource is based on first uplink grant information of the second terminal apparatus. The first terminal apparatus sends second uplink data on a second time-frequency resource. The second time-frequency resource is a part of the first time-frequency resource.

### CROSS-REFERENCE TO RELATED APPLICATIONS

This is a continuation of International Patent Application No. PCT/CN2022/119658 filed on Sep. 19, 2022, which is hereby incorporated by reference in its entirety.

### TECHNICAL FIELD

This disclosure relates to the field of communication technologies, and in particular, to a data transmission method and apparatus.

### BACKGROUND

In a mobile communication system, for example, a 5th generation mobile communication technology (5G) New Radio (NR) system, in an uplink data transmission process, when a terminal receives uplink grant information and some conditions are met, the terminal may perform uplink transmission based on a time-frequency resource configured by a network device (for example, a base station) for another terminal. This uplink transmission manner may be referred to as uplink opportunistic transmission or affiliated transmission. The terminal that transmits uplink data in the transmission manner may be referred to as a secondary terminal, and the time-frequency resource is allocated by the network device to a primary terminal.

Persons skilled in the art are working on a technical issue that how a secondary terminal determines a time-frequency resource used by the secondary terminal to perform affiliated transmission when a primary terminal performs repeated transmission, to support more secondary terminals in simultaneously performing affiliated transmission and increase a quantity of terminal devices that can be supported by a system.

### SUMMARY

This disclosure discloses a data transmission method and apparatus, to increase a quantity of terminal devices that can be supported by a system, thereby improving system performance.

According to a first aspect, an embodiment of this disclosure provides a data transmission method. The method includes a first terminal apparatus that obtains a first time-frequency resource. The first time-frequency resource is used by a second terminal apparatus to transmit first uplink data. The first time-frequency resource is determined based on first uplink grant information of the second terminal apparatus. The first terminal apparatus sends second uplink data on a second time-frequency resource. The second time-frequency resource is a part of the first time-frequency resource.

In the foregoing method, a manner in which the first terminal apparatus uses the second time-frequency resource, that is, the part of the first time-frequency resource may also be understood as a manner of using a part of all transmission occasion (TO) resources used by a primary terminal device for transmission, so that different first terminal apparatuses can multiplex a same demodulation reference signal (DMRS) port or sequence. In another case, different TO resources in all the TO resources are used for affiliated transmission. This may be understood as that the first time-frequency resource, that is, all the TO resources can be used by at least one first terminal apparatus for affiliated transmission. When this manner is compared with the case in which one first terminal apparatus uses the first time-frequency resource, that is, all the TO resources for affiliated transmission, in this manner, a quantity of first terminal apparatuses that can be supported by a system can be significantly increased without affecting transmission performance, thereby improving system performance.

In a possible implementation, that a first terminal apparatus obtains a first time-frequency resource includes that the first terminal apparatus obtains first indication information. The first indication information includes one or more of the following: information about a quantity of repeated transmissions of the second terminal apparatus, type information of repeated transmission of the second terminal apparatus, configuration information of the first time-frequency resource, frequency hopping type information, or frequency domain offset information for frequency hopping.

In still another possible implementation, the method further includes that the first terminal apparatus receives second indication information. When the first time-frequency resource includes a plurality of resources used by the second terminal apparatus to repeatedly transmit the first uplink data, the second indication information includes one or more of the following: resource index information of the second time-frequency resource and redundancy version (RV) information related to the second time-frequency resource. The first terminal apparatus determines the second time-frequency resource based on the second indication information.

In the foregoing method, in a manner in which the second indication information includes the RV information, interference control can be implemented for the second terminal apparatus, that is, the primary terminal using different RVs. For example, when the second indication information indicates that the first terminal apparatus cannot use a TO resource associated with a specific RV (for example, an RV 0 with better self-decoding reliability), a relationship between performance of the second terminal apparatus and a quantity of supported first terminal apparatuses can be better balanced.

In still another possible implementation, the method further includes that the first terminal apparatus randomly selects a part of the first time-frequency resource as the second time-frequency resource, or the first terminal apparatus determines the second time-frequency resource based on identification information of the first terminal apparatus.

In still another possible implementation, when the second terminal apparatus transmits the first uplink data in a frequency hopping transmission manner, the first time-frequency resource includes a time-frequency resource of a first hop and a time-frequency resource of a second hop, where a frequency domain resource in the time-frequency resource of the first hop does not overlap a frequency domain resource in the time-frequency resource of the second hop. The method further includes that the first terminal apparatus receives third indication information, where the third indication information includes frequency hopping index information of the first hop or frequency hopping index information of the second hop. The first terminal apparatus determines the second time-frequency resource based on the third indication information, where the second time-frequency resource includes the time-frequency resource of the first hop or the time-frequency resource of the second hop.

In the foregoing method, when the second terminal apparatus performs transmission in a frequency hopping manner, a manner in which the first terminal apparatus uses the time-frequency resource of the first hop or the time-frequency resource of the second hop, that is, the part of the first time-frequency resource may also be understood as a manner of using a part of all TO resources used by a primary terminal device for transmission, so that different first terminal apparatuses can multiplex a same DMRS port or sequence. In another case, different TO resources in all the TO resources are used for affiliated transmission. This may be understood as that the first time-frequency resource, that is, all the TO resources can be used by at least one first terminal apparatus for affiliated transmission. When this manner is compared with the case in which one first terminal apparatus uses the first time-frequency resource, that is, all the TO resources for affiliated transmission, in this manner, a quantity of first terminal apparatuses that can be supported by a system can be significantly increased without affecting transmission performance, thereby improving system performance.

In still another possible implementation, when the second terminal apparatus transmits the first uplink data in a frequency hopping transmission manner, the first time-frequency resource includes a time-frequency resource of a first hop and a time-frequency resource of a second hop, where a frequency domain resource in the time-frequency resource of the first hop does not overlap a frequency domain resource in the time-frequency resource of the second hop. The method further includes that the first terminal apparatus randomly selects a time-frequency resource of the first hop or a time-frequency resource of the second hop as the second time-frequency resource, or the first terminal apparatus determines the second time-frequency resource based on identification information of the first terminal apparatus, where the second time-frequency resource includes a time-frequency resource of the first hop or a time-frequency resource of the second hop.

In the foregoing method, when the second terminal apparatus performs transmission in a frequency hopping manner, a manner in which the first terminal apparatus uses the time-frequency resource of the first hop or the time-frequency resource of the second hop, that is, the part of the first time-frequency resource may also be understood as a manner of using a part of all TO resources used by a primary terminal device for transmission, so that different first terminal apparatuses can multiplex a same DMRS port or sequence. In another case, different TO resources in all the TO resources are used for affiliated transmission. This may be understood as that the first time-frequency resource, that is, all the TO resources can be used by at least one first terminal apparatus for affiliated transmission. When this manner is compared with the case in which one first terminal apparatus uses the first time-frequency resource, that is, all the TO resources for affiliated transmission, in this manner, a quantity of first terminal apparatuses that can be supported by a system can be significantly increased without affecting transmission performance, thereby improving system performance.

In still another possible implementation, the method further includes that the first terminal apparatus sends fourth indication information, where the fourth indication information indicates that the first terminal apparatus uses the second time-frequency resource to send the second uplink data.

In the foregoing method, the first terminal apparatus sends the fourth indication information, for example, the first terminal apparatus sends the fourth indication information to the network device, so that the network device can be notified of a resource used when the first terminal apparatus performs affiliated transmission, thereby assisting the network device in detecting and receiving the second uplink data sent by the first terminal apparatus.

In still another possible implementation, the method further includes, when a first condition is met, the first terminal apparatus cancels sending of the second uplink data on a part or all of the second time-frequency resource. The first condition includes one or more of the following: the second time-frequency resource includes a symbol that is unavailable to the first terminal apparatus, or transmission of the second terminal apparatus on the second time-frequency resource is canceled.

In the foregoing method, resource utilization can be appropriately implemented in the foregoing manner.

In still another possible implementation, that transmission of the second terminal apparatus on the second time-frequency resource is canceled includes, when first-priority service data needs to be sent on a part or all of a time domain resource in the second time-frequency resource, transmission of the second terminal apparatus on the second time-frequency resource is canceled, where a priority of the first-priority service data is higher than a priority of the first uplink data, or when a frequency domain resource used for transmitting first-priority service data overlaps a frequency domain resource in the second time-frequency resource, transmission of the second terminal apparatus on the second time-frequency resource is canceled, where a priority of the first-priority service data is higher than a priority of the first uplink data.

In still another possible implementation, the first terminal apparatus is a massive machine-type communication (mMTC) apparatus, and the second terminal apparatus is an enhanced mobile broadband (eMBB) apparatus.

According to a second aspect, this disclosure provides a data transmission method, to increase a quantity of terminal devices that can be supported by a system, thereby improving system performance. The method may be implemented by a network device or a component in a network device. The component in this disclosure is, for example, at least one of a processor, a transceiver, a processing module, or a transceiver module. For example, an execution entity is a network device. The method may be implemented by using the following steps. The network device determines first uplink grant information. The network device sends the first uplink grant information. The first uplink grant information is used for determining a first time-frequency resource. The first time-frequency resource is used by a second terminal apparatus to transmit first uplink data. The network device receives second uplink data on a second time-frequency resource. The second time-frequency resource is a part of the first time-frequency resource.

According to a third aspect, an embodiment of this disclosure provides a data transmission apparatus. The apparatus may implement the method in any possible implementation of the first aspect. The apparatus has a function of the first terminal apparatus. The apparatus is, for example, a terminal device corresponding to the first terminal apparatus, or a functional module in a terminal device.

In an optional implementation, the apparatus may include a one-to-one corresponding module for performing the method/operation/step/action described in the first aspect. The module may be a hardware circuit, or may be software, or may be implemented by a hardware circuit in combination with software. In an optional implementation, the apparatus includes a processing unit (or a processing module) and a communication unit (or a communication module). The communication unit can implement a sending function and a receiving function. When the communication unit implements the sending function, the communication unit may be referred to as a sending unit (or a sending module). When the communication unit implements the receiving function, the communication unit may be referred to as a receiving unit (or a receiving module). The sending unit and the receiving unit may be a same functional module, the functional module is referred to as a communication unit, and the functional module can implement the sending function and the receiving function. Alternatively, the sending unit and the receiving unit may be different functional modules, and the communication unit is a collective term for these functional modules.

For example, when the apparatus is configured to perform the method described in the first aspect, the apparatus may include the communication unit and the processing unit. The processing unit is configured to obtain a first time-frequency resource. The first time-frequency resource is used by a second terminal apparatus to transmit first uplink data. The first time-frequency resource is determined based on first uplink grant information of the second terminal apparatus. The communication unit is configured to send second uplink data on a second time-frequency resource. The second time-frequency resource is a part of the first time-frequency resource.

In a possible implementation, the processing unit is configured to obtain first indication information. The first indication information includes one or more of the following: information about a quantity of repeated transmissions of the second terminal apparatus, type information of repeated transmission of the second terminal apparatus, configuration information of the first time-frequency resource, frequency hopping type information, or frequency domain offset information for frequency hopping.

In still another possible implementation, the communication unit is further configured to receive second indication information. When the first time-frequency resource includes a plurality of resources used by the second terminal apparatus to repeatedly transmit the first uplink data, the second indication information includes one or more of the following: resource index information of the second time-frequency resource and RV information related to the second time-frequency resource. The processing unit is further configured to determine the second time-frequency resource based on the second indication information.

In still another possible implementation, the processing unit is further configured to randomly select a part of the first time-frequency resource as the second time-frequency resource, or the processing unit is further configured to determine the second time-frequency resource based on identification information of the first terminal apparatus.

In still another possible implementation, when the second terminal apparatus transmits the first uplink data in a frequency hopping transmission manner, the first time-frequency resource includes a time-frequency resource of a first hop and a time-frequency resource of a second hop, where a frequency domain resource in the time-frequency resource of the first hop does not overlap a frequency domain resource in the time-frequency resource of the second hop. The communication unit is further configured to receive third indication information, where the third indication information includes frequency hopping index information of the first hop or frequency hopping index information of the second hop. The processing unit is further configured to determine the second time-frequency resource based on the third indication information, where the second time-frequency resource includes the time-frequency resource of the first hop or the time-frequency resource of the second hop.

In still another possible implementation, when the second terminal apparatus transmits the first uplink data in a frequency hopping transmission manner, the first time-frequency resource includes a time-frequency resource of a first hop and a time-frequency resource of a second hop, where a frequency domain resource in the time-frequency resource of the first hop does not overlap a frequency domain resource in the time-frequency resource of the second hop. The processing unit is further configured to randomly select a time-frequency resource of the first hop or a time-frequency resource of the second hop as the second time-frequency resource, or the processing unit is further configured to determine the second time-frequency resource based on identification information of the first terminal apparatus, where the second time-frequency resource includes a time-frequency resource of the first hop or a time-frequency resource of the second hop.

In still another possible implementation, the communication unit is further configured to send fourth indication information, where the fourth indication information indicates that the second time-frequency resource is used to send the second uplink data.

In still another possible implementation, the processing unit is further configured to, when a first condition is met, cancel sending of the second uplink data on a part or all of the second time-frequency resource. The first condition includes one or more of the following: the second time-frequency resource includes a symbol that is unavailable to the first terminal apparatus, or transmission of the second terminal apparatus on the second time-frequency resource is canceled.

In still another possible implementation, when first-priority service data needs to be sent on a part or all of a time domain resource in the second time-frequency resource, transmission of the second terminal apparatus on the second time-frequency resource is canceled, where a priority of the first-priority service data is higher than a priority of the first uplink data, or when a frequency domain resource used for transmitting first-priority service data overlaps a frequency domain resource in the second time-frequency resource, transmission of the second terminal apparatus on the second time-frequency resource is canceled, where a priority of the first-priority service data is higher than a priority of the first uplink data.

In still another possible implementation, the data transmission apparatus is an mMTC apparatus, and the second terminal apparatus is an eMBB apparatus.

For example, when the apparatus is configured to perform the method described in the second aspect, the apparatus may include the communication unit and the processing unit. The processing unit is configured to obtain a first time-frequency resource. The first time-frequency resource is used by a second terminal apparatus to transmit first uplink data. The first time-frequency resource is determined based on first uplink grant information of the second terminal apparatus. The communication unit is configured to send second uplink data on a second time-frequency resource. The second time-frequency resource is a part of the first time-frequency resource. For the first uplink grant information, refer to the descriptions of the first uplink grant information in the first aspect.

For another example, the apparatus includes a processor, coupled to a memory and configured to execute instructions in the memory, to implement the method in the first aspect. Optionally, the apparatus further includes another component, for example, an antenna, an input/output module, and an interface. These components may be hardware, software, or a combination of software and hardware.

According to a fourth aspect, an embodiment of this disclosure provides a computer-readable storage medium. The computer-readable storage medium is configured to store a computer program or instructions. When the computer program or the instructions are run, the method according to any one of the first aspect, any possible implementation of the first aspect, the second aspect, or any possible implementation of the second aspect is implemented.

According to a fifth aspect, an embodiment of this disclosure provides a computer program product. The computer program product includes computer program code. When the computer program code is run on a computer, the method according to any one of the first aspect, any possible implementation of the first aspect, the second aspect, or any possible implementation of the second aspect is implemented.

According to a sixth aspect, an embodiment of this disclosure provides a chip system. The chip system includes a logic circuit (which may be alternatively understood as a case in which the chip system includes a processor, and the processor may include a logic circuit and the like). The chip system may further include an input/output interface. The input/output interface may be configured to receive a message, or may be configured to send a message. For example, when the chip system is configured to implement a function of the first terminal apparatus, the input/output interface may be configured to receive first uplink grant information. The input/output interface may be a same interface, that is, a same interface can implement both a sending function and a receiving function. Alternatively, the input/output interface includes an input interface and an output interface. The input interface is configured to implement a receiving function, that is configured to receive a message. The output interface is configured to implement a sending function, that is configured to send a message. The logic circuit may be configured to perform an operation other than a receiving/sending function in the first aspect. The logic circuit may be further configured to transmit a message to the input/output interface, or receive a message from another communication apparatus through the input/output interface. The chip system may be configured to implement the method according to any one of the first aspect, any possible implementation of the first aspect, the second aspect, or any possible implementation of the second aspect. The chip system may include a chip, or may include a chip and another discrete component.

Optionally, the chip system may further include a memory, and the memory may be configured to store instructions. The logic circuit may invoke the instructions stored in the memory to implement a corresponding function.

According to a seventh aspect, an embodiment of this disclosure provides a communication system. The communication system may include a first terminal apparatus and a network device. The first terminal apparatus may be configured to perform the method according to the first aspect, and the network device may be configured to perform the method according to the second aspect.

For technical effects brought by the second aspect to the seventh aspect, refer to the descriptions of the first aspect.

### BRIEF DESCRIPTION OF DRAWINGS

FIG. 1 is a diagram of an architecture of a wireless communication system according to this disclosure;

FIG. 2A is a diagram of a protocol stack architecture of a wireless communication system according to this disclosure;

FIG. 2B is a diagram of a protocol stack architecture of another wireless communication system according to this disclosure;

FIG. 3 is a schematic flowchart of Radio Resource Control (RRC) state switching according to this disclosure;

FIG. 4 is a schematic flowchart of a random-access method according to this disclosure;

FIG. 5 is a schematic flowchart of another random-access method according to this disclosure;

FIG. 6 is a schematic flowchart of an uplink data transmission manner according to this disclosure;

FIG. 7 is a diagram of a relationship between a beam and a spatial direction according to this disclosure;

FIG. 8 is a diagram of a relationship between a beam and a transmission resource according to this disclosure;

FIG. 9 is a schematic flowchart of an uplink opportunistic transmission method according to this disclosure;

FIG. 10 is a diagram of determining a TO resource by a primary terminal and a secondary terminal according to this disclosure;

FIG. 11 is a schematic flowchart of a data transmission method according to this disclosure;

FIG. 12 is a diagram of frequency hopping transmission according to this disclosure;

FIG. 13 is a diagram of a structure of a data transmission apparatus according to this disclosure;

FIG. 14 is a diagram of a structure of another data transmission apparatus according to this disclosure; and

FIG. 15 is a diagram of a structure of another data transmission apparatus according to this disclosure.

### DESCRIPTION OF EMBODIMENTS

The following describes embodiments of this disclosure with reference to the accompanying drawings in embodiments of this disclosure.

Embodiments of this disclosure provide a data transmission method and apparatus. The method and an apparatus are based on a same concept. Because the method and the apparatus have a similar problem-resolving principle, for implementations of the apparatus and the method, reference may be made to each other. No repeated description is provided. In descriptions of embodiments of this disclosure, the term “and/or” describes an association relationship between associated objects and indicates that three relationships may exist. For example, A and/or B may indicate the following three cases: only A exists, both A and B exist, and only B exists. The character “/” generally indicates an “or” relationship between the associated objects. In this disclosure, “at least one” means one or more, and “a plurality of” means two or more. In addition, it should be understood that in descriptions of this disclosure, terms such as “first” and “second” are merely used for distinguishing and description, but should not be understood as indicating or implying relative importance, or should not be understood as indicating or implying an order.

The data transmission method provided in embodiments of this disclosure may be applied to a 4th generation (4G) communication system, for example, a Long-Term Evolution (LTE) communication system, or may be applied to a 5G communication system, for example, a 5G NR communication system, or applied to various future communication systems, for example, a 6th generation (6G) communication system. The method provided in embodiments of this disclosure may be further applied to a BLUETOOTH system, a WI-FI system, a Long Range (LoRa) system, or an Internet of vehicles system. The method provided in embodiments of this disclosure may be further applied to a satellite communication system. The satellite communication system may be integrated with the foregoing communication system.

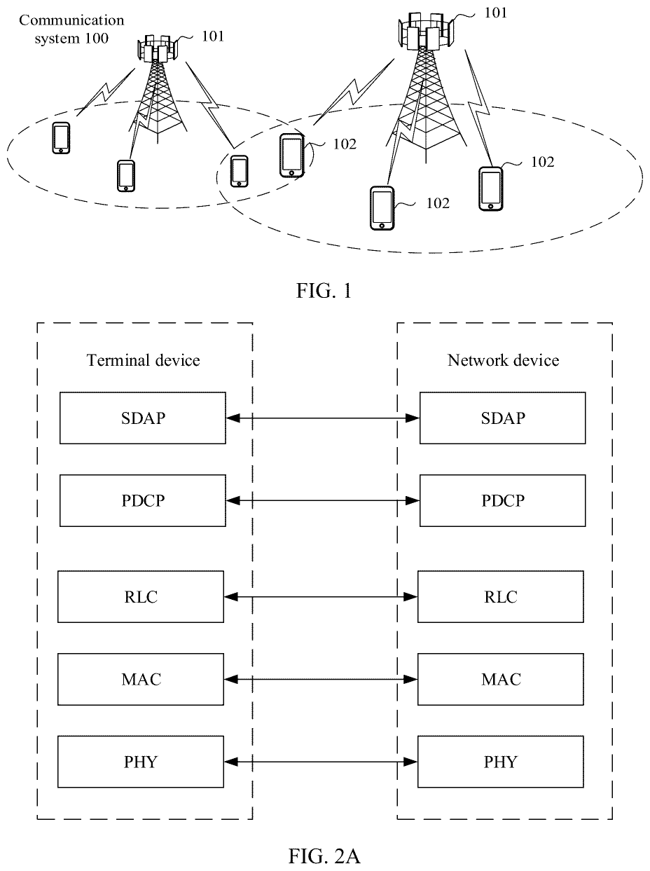

Refer to FIG. 1. FIG. 1 is a diagram of an architecture of a wireless communication system according to this disclosure. The communication system architecture shown in FIG. 1 is used as an example to describe an application scenario used in this disclosure. The communication system 100 includes a network device 101 and a terminal device 102. The apparatus provided in this embodiment of this disclosure may be applied to the network device 101 or the terminal device 102. It may be understood that FIG. 1 shows only one possible communication system architecture to which embodiments of this disclosure may be applied. In another possible scenario, the communication system architecture may alternatively include another device.

The network device 101 is a node in a radio access network (RAN), and may also be referred to as a base station or a RAN node (or device). Some examples of the network device 101 are: a gNB/NR-NodeB (NB), a transmission reception point (TRP), an evolved NodeB (eNB), a radio network controller (RNC), a NodeB (NB), a base station controller (BSC), a base transceiver station (BTS), a home base station (for example, a home evolved NodeB or a home NodeB (HNB)), a baseband unit (BBU), a WI-FI access point (AP), a satellite device, a network device in a 5G communication system, and a network device in a possible future communication system. Alternatively, the network device 101 may be another device that has a network device function. For example, the network device 101 may alternatively be a device that functions as a network device in device-to-device (D2D) communication, Internet of vehicles communication, or machine-to-machine communication. Alternatively, the network device 101 may be a network device in a possible future communication system.

In some deployments, a gNB may include a central unit (CU) and a DU. The gNB may further include a radio unit (RU). The CU implements some functions of the gNB, and the DU implements some functions of the gNB. For example, the CU implements functions of an RRC layer and a Packet Data Convergence Protocol (PDCP) layer, and the DU implements functions of a radio link control (RLC) layer, a media access control (MAC) layer, and a physical layer (PHY). Information at the RRC layer eventually becomes information at the PHY layer, or is converted from the information at the PHY layer. Therefore, in the architecture, higher layer signaling such as RRC layer signaling or PHCP layer signaling may also be considered as being sent by the DU or sent by the DU and the RU. It may be understood that the network device may be a CU node, a DU node, or a device including a CU node and a DU node. In addition, the CU may be classified as a network device in an access network RAN, or the CU may be classified as a network device in a core network CN. This is not limited herein.

The terminal device 102 may also be referred to as user equipment (UE), a terminal, a mobile station (MS), a mobile terminal (MT), or the like, and is a device that provides a user with voice or data connectivity, or may be an Internet of things device. For example, the terminal device includes a handheld device, a vehicle-mounted device, or the like that has a wireless connection function. The terminal device may be a mobile phone, a tablet computer, a laptop computer, a palmtop computer, a mobile Internet device (MID), a wearable device (for example, a smartwatch, a smart band, or a pedometer), a vehicle-mounted device (for example, a car, a bicycle, an electric car, an airplane, a ship, a train, or a high-speed rail), a virtual reality (VR) device, an augmented reality (AR) device, a wireless terminal in industrial control, a smart household device (for example, a refrigerator, a television, an air conditioner, or a meter), an intelligent robot, workshop equipment, a wireless terminal in self driving, a wireless terminal in remote surgery, a wireless terminal in a smart grid, a wireless terminal in transportation safety, a wireless terminal in a smart city, a wireless terminal in a smart home, a flight device (for example, an intelligent robot, a hot air balloon, a drone, or an airplane). Alternatively, the terminal device may be another device that has a terminal function. For example, the terminal device may alternatively be a device that functions as a terminal in D2D communication. A terminal device having wireless receiving and sending functions and a chip that can be disposed in the terminal device are collectively referred to as the terminal device in this disclosure.

When the terminal device 102 is a device in a smart factory, for example, a large quantity of different types of terminals including a sensor, a controller, a video surveillance device, and the like are centrally distributed on a lathe, an automated guided vehicle (AGV), or a mechanical arm in the smart factory, service types of these terminals are also different, and used data transmission methods are also different. A terminal device such as a sensor, a controller, and video surveillance of a high throughput service usually uses a dynamic scheduling-based transmission method. Therefore, the base station may configure the terminal device as a primary terminal, and a terminal device with a service type of small packets that randomly arrive, for example, a sensor and a controller may be configured as a secondary terminal. Correspondingly, the secondary terminal may use opportunistic multiple access (OpMA) to perform transmission by opportunistically using a dynamic resource of the primary terminal.

With reference to the communication system shown in FIG. 1, the following describes in detail a data transmission method provided in embodiments of this disclosure.

To better understand the solutions provided in embodiments of this disclosure, the following first describes some terms, concepts, or procedures in embodiments of this disclosure.

First, a status of the terminal device is described.

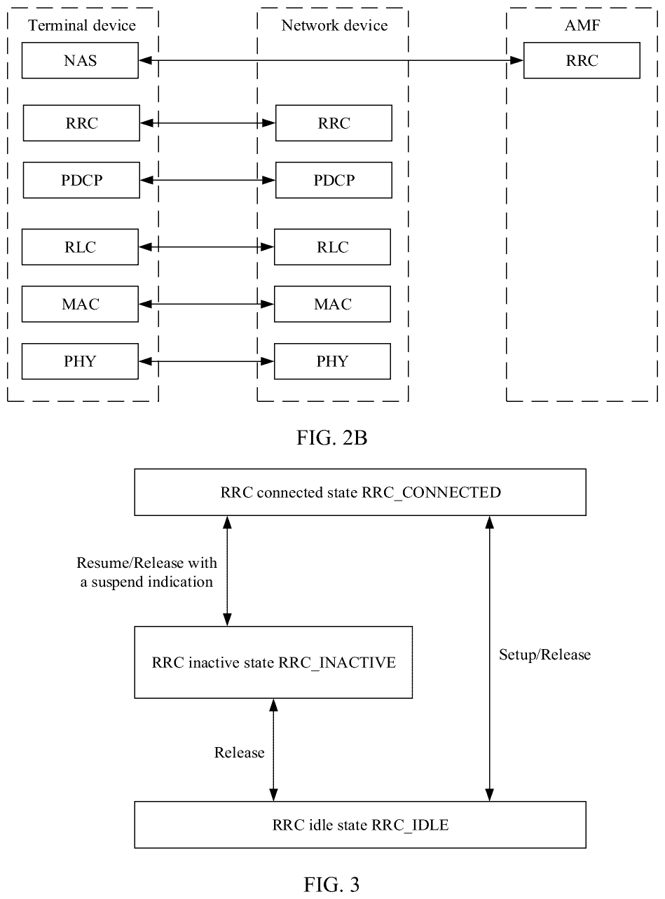

Refer to FIG. 2A. FIG. 2A is a diagram of a protocol stack architecture of a wireless communication system according to this disclosure. As shown in FIG. 2A, a user plane protocol stack for communication between a terminal device and a network device includes a service data adaptation (SDAP) layer, a PDCP layer, an RLC layer, a MAC layer, and a PHY layer.

Refer to FIG. 2B. FIG. 2B is a diagram of a protocol stack architecture of another wireless communication system according to this disclosure. As shown in FIG. 2B, a control plane protocol stack for communication between a terminal device and a network device includes a non-access stratum (NAS) layer, an RRC layer, a PDCP layer, an RLC layer, a MAC layer, and a PHY layer.

For the RRC layer, there are several RRC states of the terminal device: an RRC idle state, an RRC inactive state, and an RRC connected state. When the terminal device has set up an RRC connection, the terminal device is in the RRC_CONNECTED state or the RRC_INACTIVE state. If the terminal device does not set up an RRC connection, the terminal device is in the RRC IDLE state. The RRC_INACTIVE state is a state introduced for the terminal device in the 5G NR communication system. The RRC_INACTIVE state is mainly for a case in which “a terminal device that performs infrequent data transmission is usually kept in the RRC_INACTIVE state by a network”.

Refer to FIG. 3. FIG. 3 is a schematic flowchart of RRC state switching according to this disclosure. When the terminal device is in different RRC states, different operations are performed. As shown in FIG. 3, the terminal device is initially in the RRC_IDLE state. When the terminal device needs to perform data transmission, the terminal device performs a random-access process to set up an RRC connection to the network device, and enters the RRC_CONNECTED state. After entering the RRC_CONNECTED state, the terminal device starts to perform data transmission. To set up the RRC connection, the terminal device sends a connection setup request message, for example, RRCSetupRequest, to the network device in a process of initiating random access, and receives a connection setup message, for example, an RRCSetup message, sent by the network device.

When the terminal device does not need to perform data transmission subsequently, the network device may release the terminal device, so that the terminal device enters the RRC_IDLE state or the RRC_INACTIVE state. For example, the network device sends a release message with a suspend indication, for example, RRCRelease with suspend indication, so that the terminal device enters the RRC_INACTIVE state. Alternatively, the network device sends a release message, for example, an RRCRelease message, so that the terminal device enters the RRC IDLE state.

In addition, the terminal device in the RRC_INACTIVE state may further return to the RRC_CONNECTED state by using a resume message. For example, the terminal device sends an RRC resume request (RRCResumeRequest), receives an RRC resume (RRCResume) message, and returns to the RRC_CONNECTED state. Similarly, the network device may further release the terminal device, so that the terminal device enters the RRC IDLE state.

For brief description, the RRC_IDLE state may also be briefly described as an idle state or an IDLE state, the RRC_INACTIVE state may also be briefly described as an inactive state or an INACTIVE state, and the RRC_CONNECTED state may also be briefly described as a connected state, an active state, or a CONNECTED state.

In conclusion, the several RRC states (or states) of the terminal device have been described. Embodiments of this disclosure may be used by the terminal device in the RRC connected state, the RRC idle state, or the RRC inactive state to implement uplink data transmission, or may be used by a terminal device in a state other than the RRC connected state, the RRC idle state, and the RRC inactive state, for example, a terminal device that is not attached to a network or that does not perform downlink synchronization with the network, to implement uplink data transmission. This is not further required.

The terminal device in the RRC idle state or the RRC inactive state needs to complete setup of an RRC connection by performing a random-access (RA) process. It may be understood that the RA may include 4-step RA and 2-step RA.

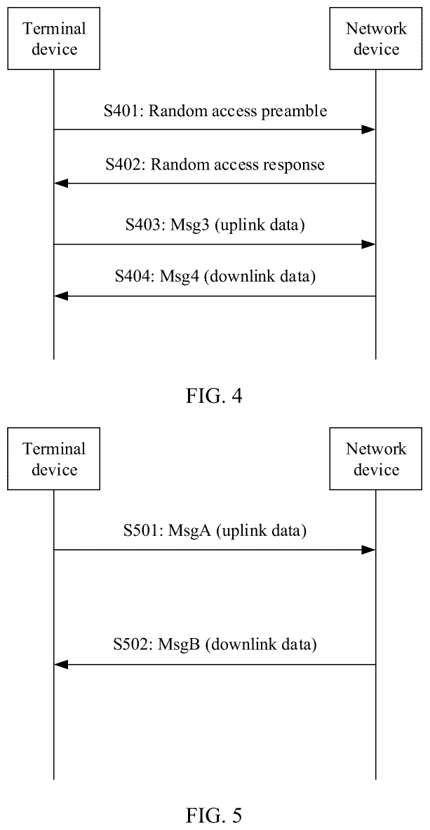

Refer to FIG. 4. FIG. 4 is a schematic flowchart of a random-access method according to this disclosure. Further, a small packet transmission process in 4-step RA is used as an example.

S401: The terminal device sends a message 1 (Msg1) to the network device, and the network device receives the message 1 from the terminal device, where the message 1 is a random access preamble (or a preamble), and the preamble is used by the network device to estimate a timing advance (TA) of the terminal device.

S402: The network device sends a message 2 (Msg2) to the terminal device, and the terminal device receives the message 2 from the network device.

The message 2 is a random-access response.

S403: The terminal device sends a message 3 (Msg3) to the network device, and the network device receives the message 3 from the terminal device.

The Msg3 may carry uplink data, for example, small packet data.

S404: The network device sends a message 4 (Msg4) to the terminal device, and the terminal device receives the message 4 from the network device.

Optionally, downlink data is carried in the Msg4.

Refer to FIG. 5. FIG. 5 is a schematic flowchart of another random-access method according to this disclosure. Further, a small packet transmission process in 2-step RA is used as an example.

S501: The terminal device sends a message A (MsgA) to the network device, and the network device receives the message A from the terminal device.

The MsgA may carry uplink data, for example, small packet data.

A transmission channel of the MsgA may include a physical random-access channel (PRACH) and a physical uplink shared channel (PUSCH). The PRACH is used to send a preamble, used by the network device to estimate a timing advance of the terminal device, so that the terminal device implements uplink synchronization with the network device. The terminal device may further send the uplink data (for example, the small packet data) through the PUSCH of the MsgA. In other words, the PUSCH may be used to carry the uplink data.

S502: The network device returns a message B (MsgB) to the terminal, and the terminal device receives the message B from the network device.

Downlink data may be carried in the MsgB. Early transmitted downlink data may be transmitted through a physical downlink shared channel PDSCH of the MsgB.

In this disclosure, the terminal device may send the uplink data to the network device.

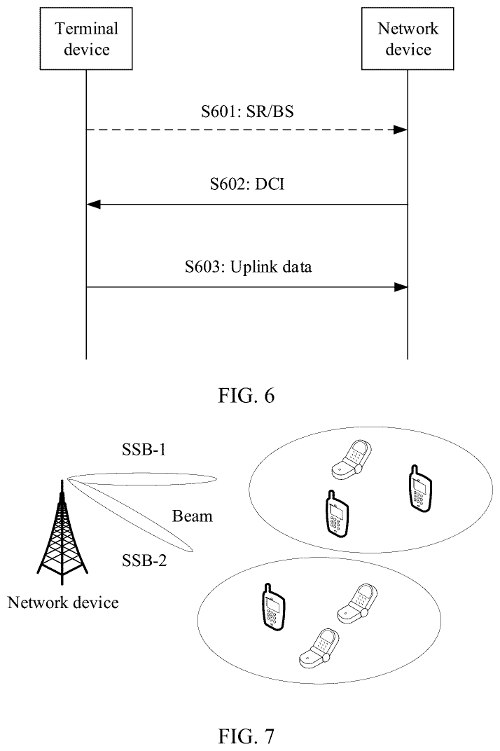

Refer to FIG. 6. FIG. 6 is a schematic flowchart of an uplink data transmission manner according to this disclosure. The uplink data transmission manner is uplink transmission based on a dynamic grant (DG) (or referred to as a dynamic uplink (UL) grant.

S601: A terminal device sends an SR/a BS to a network device.

Before monitoring DCI, the terminal device may first send the scheduling request (SR) to the network device through a physical uplink control channel (PUCCH) or report a buffer state (BS) to the network device through a physical uplink shared channel (PUSCH), to notify the network device of an uplink sending requirement or the buffer state. This helps the network device perform uplink grant and resource scheduling based on the requirement.

S602: The network device sends the DCI to the terminal device.

When the terminal device needs to send user plane data to the network device, the terminal device may monitor downlink control information (DCI) delivered by the network device through a physical downlink control channel (PDCCH). The DCI carries an uplink grant (UL grant). The uplink grant may be used to authorize the terminal device to send the uplink data on a specified time-frequency resource by using a specified parameter, for example, a specified modulation and coding scheme (MCS).

S603: The terminal device sends uplink data to the network device.

It may be understood that the uplink data transmission manner provided in this embodiment of this disclosure may further include a grant-free (GF) data transmission process. The GF data transmission process includes two types: a first-type dynamic grant-free transmission process and a second-type dynamic grant-free transmission process respectively. The first-type dynamic grant-free transmission process means that a resource such as a time-frequency signal and/or a reference signal used for transmission, for example, a DMRS is configured by the network device by using terminal-specific signaling such as a terminal-specific RRC message, or a resource such as a time-frequency reference signal used for transmission is specific to the terminal instead of being used by a plurality of terminals through contention. This may also be understood as that the terminal device directly uses a resource preconfigured by the network device to send data, and does not need to send a random-access preamble. This is applicable to a case in which the terminal device and the network device have completed uplink synchronization, for example, semi-persistent scheduling (SPS) and transmission based on a preconfigured uplink resource (PUR) in LTE, configured grant (CG) transmission in 5G NR, and CG-based small data transmission CG-SDT. The second-type dynamic grant-free transmission process means that a resource such as a time-frequency resource used for transmission is configured by the network device by using a broadcast message such as a system message, or a resource such as a time-frequency resource used for transmission is not specific to the terminal but is used by a plurality of terminals through contention. It may be understood that the terminal device completes uplink data transmission in a random-access process. For example, 4-step RA (or early data transmission (EDT)) of uplink and downlink data transmission is separately completed in the Msg3 and the Msg4, and 2-step RA of uplink and downlink data transmission is separately completed in the MsgA and the MsgB. This type of dynamic grant-free transmission technology is also referred to as RA-based small data transmission (RA-SDT) in 5G NR. A characteristic of this type of transmission technology is that the terminal needs to send a random-access preamble to the base station before sending data (Msg1) or when sending data (MsgA). The random-access preamble is used for uplink synchronization between the terminal and the base station. A common characteristic of the two types of dynamic grant-free transmission processes is that before uplink transmission, the terminal device does not need to obtain, by monitoring a dynamic grant of the network device, a time-frequency resource and a transmission parameter that are used for sending data, but sends the data to the network device by using a preconfigured time-frequency resource and transmission parameter. The time-frequency resource and the transmission parameter that are used for data transmission are usually configured by the network device by using higher layer signaling such as a system message (SI) or terminal-specific (UE-specific) RRC signaling such as an RRC reconfiguration message or an RRC release message.

That terminal devices multiplex a same time-frequency resource to transmit uplink data is an important means of supporting massive connectivity. Dynamic grant-free transmission naturally supports multi-terminal multiplexing. For example, in the CG, the network device may configure a same time-frequency resource and mutually orthogonal or quasi-orthogonal reference signals such as a DMRS for a plurality of terminals by using higher layer signaling. In this way, when the plurality of terminal devices send data by using the same time-frequency resource, the network device may detect the plurality of terminals and receive the data by using a DMRS. However, in dynamic grant-based uplink transmission, a multi-user multiple-input multiple-output (MU-MIMO) technology is further needed for implementation. However, this technology greatly depends on accurate obtaining of uplink channel information of the terminal device by the network device, and overheads are relatively high. For example, the network device needs to deliver a channel state information reference signal (CSI-RS) for the terminal device to measure and report channel information, or the terminal device needs to send a channel sounding reference signal (SRS), and pairing between terminal devices is complex. Therefore, the MU-MIMO technology is mainly used to improve an uplink throughput rate, but does not significantly improve a quantity of connections.

In addition, a synchronization signal (SS)/physical broadcast channel (PBCH) block is further introduced in 5G NR. In this disclosure, the SS/PBCH block may also be referred to as a synchronization signal block (SSB). The SSB may include three parts: a primary synchronization signal (PSS), a secondary synchronization signal (SSS), and a master information block (MIB).

The network device sends a plurality of SSBs in a scanning manner in one periodicity, and different SSBs correspond to different spatial directions (for example, correspond to different beams). Therefore, a beam indication may also be implemented by using the SSB, or the SSB may be used as beam information. For example, as shown in FIG. 7, FIG. 7 is a diagram of a relationship between a beam and a spatial direction according to this disclosure. SSB-1 and SSB-2 respectively cover different areas, and different areas may include different terminal devices. A quantity of SSBs may be configured by the network device for the terminal device by using a system message. Three quantities of SSBs: 4, 8, and 64 are supported in NR. Generally, a higher frequency indicates a larger quantity of SSBs and narrower beams for sending the SSBs.

The terminal device may measure a reference signal received power (RSRP) of an SSB sent by the network device. When an RSRP measurement result of an SSB is greater than or equal to a preset threshold, the terminal device may select an access channel occasion (RACH occasion (RO)) or a preamble to which the SSB is mapped, to perform an RA process, where one PRACH time-frequency resource may be referred to as one physical random-access channel occasion. Therefore, there is a mapping relationship between an SSB and an RO or a preamble, and the mapping relationship may be one-to-many, one-to-one, or many-to-one. When performing 2-step RA or 4-step RA, the terminal device may notify the network device of the selected SSB in an implicit manner by using the selected RO or preamble. In this way, when sending a response message (the MsgB or the Msg2), the network device may send the response message in a spatial direction that is the same as that of the SSB to which the RO or the preamble selected by the terminal device is mapped. When receiving the response message, the terminal device also assumes that a quasi co-location (QCL) feature is the same as that of the SSB to which the selected RO or preamble is mapped, so that the terminal device can implicitly indicate the SSB to the network device. The QCL feature may also be referred to as a QCL relationship. The QCL relationship means that two reference signals have some same spatial parameters. The SSB is implicitly indicated through RA, so that the network device can preliminarily determine a location of the terminal device, to perform more accurate beam management. The terminal device measures an SSB sent by the network device. When a measurement result of an SSB exceeds a preset threshold, the terminal device may select an RO or a Preamble to which the SSB is mapped, to perform the RA process. Similar to RA, there may also be a mapping relationship between an SSB and a grant-free transmission resource in GF transmission. For example, there is a mapping relationship between an SSB and a time-frequency resource, that is, a TO or a DMRS. The relationship may also be one-to-many, one-to-one, or many-to-one.

Based on the foregoing descriptions of the small data transmission and the descriptions of an SSB configuration manner, in current GF transmission, the network device configures, for the terminal device by using a terminal device-specific RRC message, a grant-free resource used for direct small data transmission in an inactive state, and the grant-free resource includes a periodic time-frequency resource, a DMRS resource, and a transmission parameter such as an MCS. When the terminal device has an uplink data packet transmission requirement, the terminal device sends data by using the configured time-frequency resource. When the time-frequency resource is shared by a plurality of terminal devices, the network device may distinguish between the terminals by using DMRS resources such as DMRS ports or DMRS sequences. For example, different terminal devices use different DMRS ports or sequences.

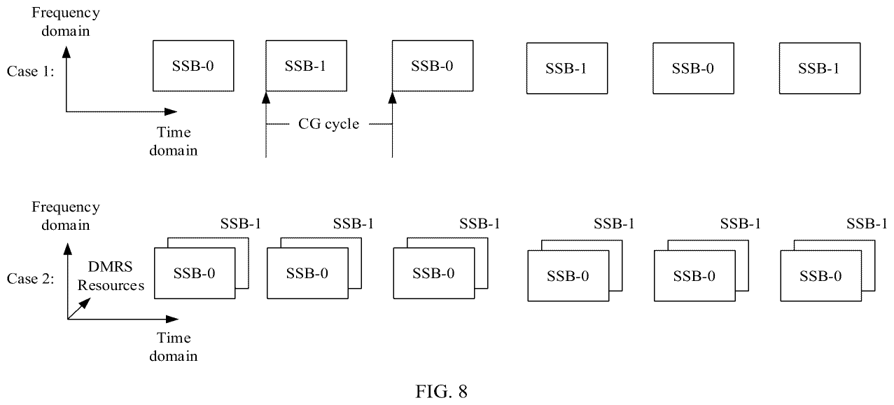

In addition, when configuring the time-frequency resource and the DMRS resource for the terminal device, the network device associates the configured resource with a beam such as an SSB. In this way, the terminal device selects, based on a beam measurement result, a time-frequency resource or a DMRS resource associated with a beam to send data, to implement a beam indication, and the network device receives, on the associated time-frequency resource by using a beam direction and by using the associated DMRS, the data sent by the terminal. For example, a method for associating a beam manner with a grant-free time-frequency resource and a DMRS resource is as follows: N (N≥1) SSBs are mapped to a plurality of combinations of time-frequency resources and DMRSs in an order of first the DMRS resource (port or sequence) and then the time-frequency resource. For example, when N=2, two different SSBs may be mapped to different time-frequency resources (as shown in a case 1 in FIG. 8) or different DMRS resources on a same time-frequency resource (as shown in a case 2 in FIG. 8).

To consider transmission of all terminals whose service types support GF transmission in a cell, the network device needs to configure a corresponding SSB for each terminal. However, because the terminals may be completely scattered in the cell, it means that the network device needs to configure associated time-frequency resources and DMRS resources for all or most beam directions (such as SSBs). As a result, time-frequency resources mapped to a same beam direction have a large time interval. Consequently, a quantity of terminal devices that perform multiplexing transmission within specific time is limited, and it is difficult to meet a terminal multiplexing transmission requirement brought by an increasing quantity of terminals. In addition, in a high-frequency scenario, a beam is narrower, and there are more beam directions. In addition, due to a limited quantity of receive and transmit channels, the network device can simultaneously serve a limited quantity of beam directions, and a quantity of terminal devices that can perform multiplexing transmission is further limited.

In addition, the International Telecommunication Union (ITU) defines three major types of application scenarios for 5G and a future mobile communication system: eMBB, ultra-reliable low-latency communication (URLLC), and mMTC. Typical eMBB services include an ultra high-definition video, augmented reality (AR), virtual reality (VR), and the like. These services are mainly characterized by a large transmission data amount and a very high transmission rate. Typical URLLC services include wireless control in an industrial manufacturing or production process, motion control and remote repair of a self-driving car and an unmanned aircraft, a tactile interaction application such as remote surgery, and the like. These services have ultra-high reliability, a low latency, a small data transmission amount, and burstiness. Typical mMTC services include smart grid distribution automation, smart cities, and the like. These services are mainly characterized by a huge quantity of network-connected devices, a small data transmission amount, and insensitivity of data to a transmission latency. These mMTC terminals need to meet requirements of low costs and extremely long standby duration.

Technical terms in embodiments of this disclosure are explained below.

Repeated transmission of the terminal device: The terminal device repeatedly transmits a same piece of data. After performing previous transmission, the terminal device automatically performs next transmission without waiting for feedback of the network device for the previous transmission. Time domain resources used for two adjacent transmissions may be continuous in time, or may be discontinuous in time, may be in a same slot, or may be in different slots, and may include a same quantity of or different quantities of time domain symbols. This is not limited in this embodiment of this disclosure. Retransmission of the terminal device: The terminal device repeatedly transmits a same piece of data. After performing previous transmission, the terminal device needs to wait for feedback of the network device for the previous transmission before determining whether to perform next transmission. It should be noted that, unless otherwise specified, transmission mentioned in this embodiment of this disclosure is repeated transmission of the terminal device instead of retransmission of the terminal device.

RV: A same RV or different RVs of a same piece of data may be repeatedly transmitted. One RV corresponds to one part of data after channel encoding. Different RVs correspond to different parts. Usually, RVs are numbered, for example, 0, 1, 2, and 3. For ease of description, a time domain resource or a time-frequency resource used for one time of repeated transmission (or repetition) is referred to as a TO.

In addition, the terminal device may further send uplink data to the network device by using a data transmission method based on opportunistic multiple access (OpMA) or a data transmission method based on affiliated multiple access (AMA). The method may also be referred to as opportunity-based multiple access (OBMA) transmission. In uplink opportunistic transmission, the terminal may determine a beam direction based on received uplink grant information, and when the beam direction meets a preset condition, the terminal sends uplink data to the network device by using a time-frequency resource corresponding to the uplink grant information. The time-frequency resource corresponding to the uplink grant information is used by a primary terminal to send the uplink data. In other words, the time-frequency resource is allocated to the primary terminal.

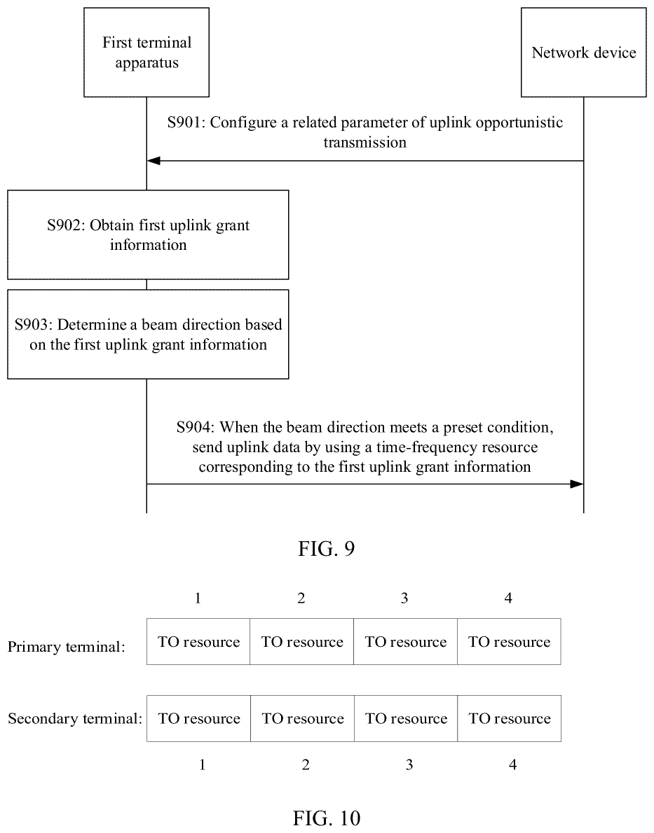

In the following, an example in which a first terminal apparatus, a second terminal apparatus, and the network device are execution bodies is used for description. The first terminal apparatus may be a first terminal device or a component in a first terminal device, and the second terminal apparatus may be a second terminal device or a component in a second terminal device. Optionally, the first terminal device and the second terminal device are different terminal devices. For example, optionally, the first terminal device and the second terminal device are different terminals in coverage of a same beam. In this disclosure, the second terminal device may be used as a primary terminal, in other words, a time-frequency resource corresponding to first uplink grant information is originally allocated by the network device to the second terminal device. The first terminal device may be used as a secondary terminal in this disclosure. In some conditions, the secondary terminal in this disclosure may perform uplink data transmission by using the time-frequency resource allocated by the network device to the primary terminal. Alternatively, both the first terminal device and the second terminal device are used as secondary terminals, or the second terminal device is one or more secondary terminals including the first terminal device. In this case, there may be no primary terminal, in other words, there is no need to distinguish between the primary terminal and the secondary terminal. The following describes a procedure of the method with reference to FIG. 9.

Refer to FIG. 9. FIG. 9 is a schematic flowchart of an uplink opportunistic transmission method according to this disclosure. The method may include the following steps.

S901: The network device configures a related parameter of uplink opportunistic transmission for the first terminal apparatus, where the parameter is used by the first terminal apparatus to perform uplink transmission.

For example, the network device may configure at least one of a beam direction, a terminal type, a transmission resource, and a transmission parameter for the first terminal apparatus and/or the second terminal apparatus. For example, the network device sends configuration information to the first terminal apparatus or the second terminal apparatus by using signaling such as an RRC message, a MAC CE, or DCI, to configure an uplink transmission mode that is based on opportunistic multiple access and/or a related parameter. The related parameter includes but is not limited to a terminal identifier, a beam direction, a transmission resource used to send data, a transmission parameter, and a parameter used to receive an uplink grant, for example, a radio network temporary identifier (RNTI), a control resource set (CORESET), search space (SS), or a signaling format.

S902: The first terminal apparatus obtains first uplink grant information.

The first uplink grant information may be from the network device, or the first uplink grant information is sent by the network device to the first terminal apparatus, and is used to schedule uplink data transmission of the second terminal apparatus.

S903: The first terminal apparatus determines a beam direction based on the first uplink grant information.

The first uplink grant information obtained by the first terminal apparatus may include beam indication information (or indication information of the beam direction) used to explicitly indicate the beam direction, or the first uplink grant information may be used to implicitly indicate the beam direction. For example, the beam indication information may include indication information of a reference signal associated with the beam direction or a beam direction identifier. The indication information of the reference signal associated with the beam direction includes, for example, an index of the reference signal representing the beam direction, for example, an SSB index or a CSI-RS index. The beam direction identifier may be, for example, an index or an identifier corresponding to the beam direction.

S904: When the beam direction meets a preset condition, the first terminal apparatus sends uplink data to the network device by using a time-frequency resource corresponding to the first uplink grant information.

For example, the preset condition includes at least one of a condition 1 and a condition 2. The condition 1 is that a signal measurement value corresponding to the beam direction meets a threshold condition. The condition 2 is that a beam direction of the first terminal apparatus includes the beam direction. In the condition 1, the first terminal apparatus may determine, based on a measurement result of the beam direction, whether the beam direction needs to meet the preset condition. For example, when the reference signal can represent the beam direction, the first terminal apparatus determines, based on a measurement value of signal quality of the reference signal corresponding to the beam direction and a threshold condition (or a signal quality threshold), whether the beam direction meets the preset condition. The signal quality herein includes but is not limited to measurement of a reference signal received power (RSRP), reference signal received quality (RSRP), a signal-to-interference-plus-noise ratio (SINR), a received signal strength indicator (RSSI), a path loss (PL), an angle of arrival (AoA) of the signal, and a time difference of arrival (TDOA). For example, when the RSRP of the reference signal exceeds a preset RSRP threshold, the first terminal apparatus determines that the beam direction meets the preset condition. In the condition 2, when the network device configures a transmission resource such as a grant-free transmission resource for the first terminal apparatus, the preset condition may include whether the beam direction is (or is included in) a beam direction configured by the network device for grant-free transmission of the first terminal apparatus. If the beam direction is the beam direction configured by the network device for the grant-free transmission of the first terminal apparatus, or the beam direction is included in the beam direction configured by the network device for the grant-free transmission of the first terminal apparatus, the first terminal apparatus may determine that the beam direction meets the preset condition.

Based on the procedure shown in FIG. 9, as shown in FIG. 10, FIG. 10 is a diagram of determining a TO resource by a primary terminal and a secondary terminal according to this disclosure. It is assumed that when the primary terminal device performs repeated transmission, four TO resources are used, and when the secondary terminal performs affiliated transmission, all the TOs of the primary terminal, that is, the four TO resources are used for repeated transmission or low bit rate transmission. However, generally, if the network device is to successfully decode data of the primary terminal and the secondary terminal, DMRS ports or sequences with orthogonality or relatively good orthogonality need to be used between the primary terminal and the secondary terminal. However, orthogonal DMRS ports or sequences are limited. Therefore, if all secondary terminals perform affiliated transmission by using all the TOs of the primary terminal, a quantity of supported secondary terminals is limited by a quantity of orthogonal DMRS ports or sequences. For example, it is assumed that there are K orthogonal DMRS ports in total, and it is required that orthogonal DMRS ports are used between the primary terminal and the secondary terminal. In this case, a maximum quantity of secondary terminals that can be supported at the same time is K−1. As a result, due to limitation of the quantity of orthogonal DMRS ports, a quantity of user connections that can be supported by a system is affected, thereby affecting system performance.

To increase the quantity of user connections that can be supported by the system and improve the system performance, an embodiment of this disclosure provides a data transmission method. The method may be implemented by a network device and a terminal apparatus. For example, the network device may include the network device 101 shown in FIG. 1, and the terminal apparatus may include the terminal device 102 shown in FIG. 1. It should be understood that a step performed by the terminal apparatus in the method may alternatively be performed by a component (such as a chip, a module, or a circuit) in the terminal apparatus, and/or a step performed by the network device in the method may alternatively be performed by a component (such as a chip, a module, or a circuit) in the network device. The terminal apparatus may include a first terminal apparatus and a second terminal apparatus. For the first terminal apparatus and the second terminal apparatus, refer to the foregoing related descriptions.

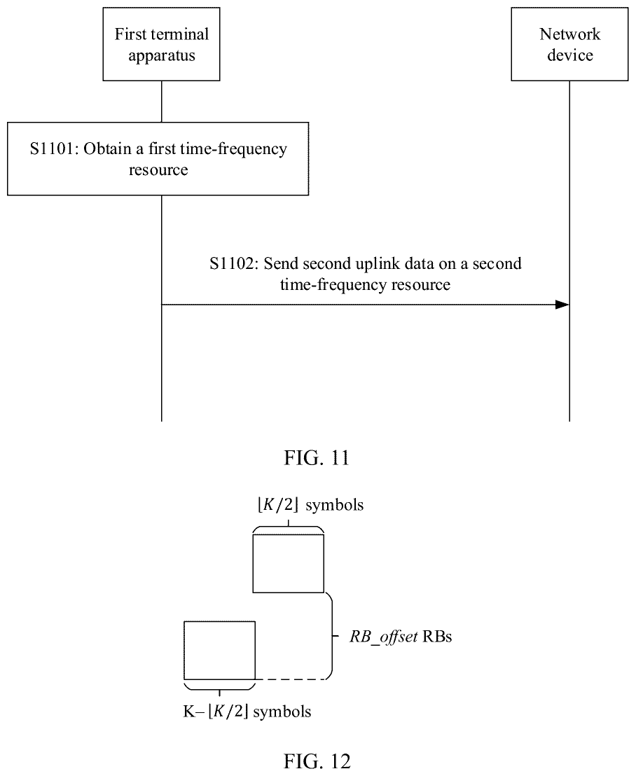

Refer to FIG. 11. FIG. 11 is a schematic flowchart of a data transmission method according to this disclosure. The method may include steps shown in S1101 and S1102. The following separately describes the steps.

S1101: A first terminal apparatus obtains a first time-frequency resource.

The first time-frequency resource is used by a second terminal apparatus to transmit first uplink data. The first time-frequency resource is determined based on first uplink grant information of the second terminal apparatus. Details are as follows.

In an example, the first uplink grant information may include time-frequency resource information of the first time-frequency resource. In other words, the first time-frequency resource corresponding to the first uplink grant information is indicated by the first time-frequency resource information included in the first uplink grant information. For example, the first uplink grant information includes time domain location information and frequency domain location information of the first time-frequency resource.

In another example, a network device may configure a transmission resource set for a terminal by using an RRC message, a MAC CE, or DCI. The first uplink grant information may carry indication information indicating a specific transmission resource from the transmission resource set. The transmission resource may include the first time-frequency resource (to be specific, a time domain resource and a frequency domain resource). In addition, the transmission resource may further include a space domain resource, a code domain resource (such as a DMRS), a multiple access signature, or the like. The first time-frequency resource determined based on the indication information in the first uplink grant information is the first time-frequency resource corresponding to the first uplink grant information. For example, the first uplink grant information may include an index of the first time-frequency resource in the resource set.

In another example, the first time-frequency resource indicated by the first uplink grant information may be a first time-frequency resource corresponding to at least one of an RNTI, a CORESET, search space, or a signaling format used to receive the first uplink grant information. In other words, the first time-frequency resource indicated by the first uplink grant information is implicitly indicated by using the at least one of the RNTI, the CORESET, the search space, or the signaling format used to receive the first uplink grant information. For example, the at least one of the RNTI, the CORESET, the search space, or the signaling format used to receive the first uplink grant information corresponds to a transmission resource. Optionally, the first terminal apparatus may receive a first correspondence from the network device, where the first correspondence may include a correspondence between the transmission resource and the at least one of the RNTI, the CORESET, the search space, or the signaling format used to receive the first uplink grant information. Alternatively, the first correspondence may be stored in the first terminal apparatus. For example, the correspondence may be pre-configured by the network device by using signaling, or may be defined in a protocol, or may be pre-configured in the first terminal apparatus. When receiving the first uplink grant information based on the at least one of the RNTI, the CORESET, the search space, or the signaling format, the first terminal apparatus may further determine the first time-frequency resource corresponding to the first uplink grant information, based on the first correspondence and the at least one of the RNTI, the CORESET, the search space, or the signaling format of the first uplink grant information.

It may be understood that, for the network device that sends the first uplink grant information, the foregoing RNTI, CORESET, search space, or signaling format used to receive the first uplink grant information may be referred to as an RNTI, a CORESET, search space, or a signaling format used to send the first uplink grant information.

Optionally, the at least one of the RNTI, the CORESET, the search space, or the signaling format used to receive the first uplink grant information may be allocated to one or more terminals (including the first terminal apparatus and/or the second terminal apparatus).

For example, the first correspondence includes a correspondence between an RNTI-1 and a time-frequency resource 1. When the first terminal apparatus receives the first uplink grant information based on the RNTI-1, the first time-frequency resource corresponding to the first uplink grant information is the time-frequency resource 1.

It should be understood that the first time-frequency resource corresponding to the first uplink grant information may be a first time-frequency resource allocated by the network device to the second terminal apparatus. Therefore, the second terminal apparatus may perform uplink transmission by using the first time-frequency resource.

It should be noted that the first uplink grant information may be from the network device, or may be from the second terminal apparatus, and further includes the following two possible implementations:
(1) In a first possible implementation, the first uplink grant information is dynamic grant information sent by the network device. For example, according to the descriptions in this disclosure, the second terminal apparatus may send a scheduling request to the network device through a PUCCH, or the second terminal apparatus may send a buffer state to the network device through the PUSCH, and then the network device may send the first uplink grant information, to schedule uplink data transmission of the second terminal apparatus. Optionally, the first uplink grant information may include the first time-frequency resource used by the second terminal apparatus to perform uplink data transmission. Optionally, the first uplink grant information may be sent by the network device in a unicast, groupcast, or broadcast manner.

For example, the first uplink grant information may be a physical layer signal. For example, the first uplink grant information is DCI, and the first uplink grant information may be sent through a PDCCH. For another example, the first grant information may alternatively be a MAC layer signal, for example, a MAC control element (CE). In this case, the first grant information may be delivered through, for example, a PDSCH. A difference between the DCI and the MAC control element lies in that the DCI is usually sent after being scrambled by using a specific RNTI. Therefore, the terminal can correctly receive the DCI sent by the base station to the terminal only after determining the RNTI. However, the MAC CE does not need to be scrambled by using a specific RNTI before being received.

If the first uplink grant information is the DCI, the RNTI used by the first terminal apparatus to receive the first uplink grant information may be pre-configured by the network device by using signaling. For example, the network device may configure the RNTI for the first terminal apparatus by using an RRC message, a MAC CE, or DCI. Optionally, the RNTI may be an RNTI configured by the network device for the second terminal apparatus, for example, a C-RNTI. In this case, the first terminal apparatus and the second terminal apparatus share the RNTI.

Alternatively, the RNTI may be calculated by the first terminal apparatus based on a resource such as the time domain resource, the frequency domain resource, the code domain resource, or the multiple access signature. For example, the network device configures, for the first terminal apparatus, a transmission resource including the time domain resource, the frequency domain resource, the code domain resource, the multiple access signature, or the like, where the transmission resource is, for example, a grant-free transmission resource. The terminal may calculate the RNTI based on the resources, and receive, based on the RNTI, the first uplink grant information sent through the PDCCH. For example, a corresponding RNTI is set for a grant-free resource, or a corresponding parameter used to calculate the RNTI is set for a grant-free resource and is used by the first terminal apparatus to calculate the RNTI.

It should be understood that, the first uplink grant information herein may be sent by the network device to the second terminal apparatus, and the network device may configure a transmission resource including any one or more of the time domain resource, the frequency domain resource, the code domain resource, the multiple access signature, or the like for at least one terminal apparatus (including the first terminal apparatus) in advance, where the transmission resource is, for example, a grant-free transmission resource. When sending dynamic grant information (for example, the first time-frequency resource indicating the second terminal apparatus to perform uplink transmission) to the second terminal apparatus, the network device calculates an RNTI of the dynamic grant information based on the configured transmission resource, and sends the dynamic grant information based on the RNTI. If the first terminal apparatus has an uplink transmission requirement, the first terminal apparatus may also calculate the RNTI based on the configured transmission resource. If the first terminal apparatus successfully receives the dynamic grant information based on the RNTI, the dynamic grant information may be used as the first uplink grant information. If the first terminal apparatus does not successfully receive the dynamic grant information based on the RNTI, it indicates that there is no uplink grant information corresponding to the first time-frequency resource.

The code domain resource herein may be a DMRS resource such as a DMRS port, a preamble resource, or a sequence resource. The sequence resource includes, for example, a ZC (Zadoff-Chu) sequence, a covered-ZC sequence, a pseudo-noise (PN) sequence, a longest linear feedback shift register (M) sequence, a Golden sequence, a Reed-Muller sequence, a discrete Fourier transform (DFT) sequence, an inverse DFT (IDFT) sequence, or a Hadamard sequence.

The multiple access signature herein includes but is not limited to a codebook, a pattern, a sequence, and the like that can be used for, that can assist, or that can enhance multi-user detection or multi-data reception, for example, a spreading sequence, a spreading pattern, a resource mapping pattern or a resource hopping pattern

In the first implementation, the first uplink grant information may include explicit indication information of a transmission resource and/or a transmission parameter, or the first uplink grant information may include the transmission resource and/or the transmission parameter. The transmission resource and/or the transmission parameter may be used by the first terminal apparatus to send the uplink data. In this disclosure, the transmission resource includes but is not limited to any one or more resources such as the time domain resource, the frequency domain resource, the code domain resource, or the multiple access signature resource. The transmission parameter in this disclosure includes but is not limited to a parameter such as an MCS, a power control parameter, or a quantity of repeated transmissions. The first terminal apparatus may send the uplink data to the network device based on the transmission resource and/or the transmission parameter.

Further, the first uplink grant information may further include resource information of the transmission resource and/or the transmission parameter. Therefore, the first uplink grant information may directly indicate the transmission resource and/or the transmission parameter. Alternatively, the first uplink grant information may indicate a transmission resource from a transmission resource set, and the transmission resource set may be indicated by the network device by using an RRC message, a MAC CE, or DCI, and/or the first uplink grant information may indicate a transmission parameter from a transmission parameter set, where the transmission parameter set may be indicated by the network device by using an RRC message, a MAC CE, or DCI.

In addition, the first uplink grant information may implicitly indicate the transmission resource and/or the transmission parameter. For example, as described above, the at least one of the RNTI, the CORESET, the search space, or the signaling format used to receive the first uplink grant information may correspond to the transmission resource. Therefore, after the first terminal apparatus receives the first uplink grant information, the transmission resource corresponding to the at least one of the RNTI, the CORESET, the search space, or the signaling format may be used as the transmission resource used to send the uplink data.

Similarly, the at least one of the RNTI, the CORESET, the search space, or the signaling format used to receive the first uplink grant information may correspond to the transmission parameter, and the transmission parameter corresponding to the at least one of the RNTI, the CORESET, the search space, or the signaling format may be used as the transmission parameter used to send the uplink data.

Optionally, the first terminal apparatus may receive a second correspondence from the network device, where the second correspondence may include a correspondence between the transmission parameter and the at least one of the RNTI, the CORESET, the search space, or the signaling format used to receive the first uplink grant information. Alternatively, the second correspondence may be stored in the first terminal apparatus. For example, the correspondence may be pre-configured by the network device by using signaling, or may be defined in a protocol, or may be pre-configured in the first terminal apparatus. When receiving the first uplink grant information based on the at least one of the RNTI, the CORESET, the search space, or the signaling format, the first terminal apparatus may further determine the transmission parameter based on the second correspondence and the at least one of the RNTI, the CORESET, the search space, or the signaling format of the first uplink grant information.

In addition, optionally, in the first implementation, the first uplink grant information may be used by the first terminal apparatus to determine a beam direction corresponding to the first uplink grant information, where the first uplink grant information may include indication information of the beam direction, or the first uplink grant information may implicitly indicate the beam direction. The beam direction may be used by the first terminal apparatus to determine whether to send the uplink data on the first time-frequency resource corresponding to the first uplink grant information. For details, refer to the foregoing descriptions. A beam herein may be a beam used by the network device for reception.

In an example, the first uplink grant information may include beam indication information (or indication information of the beam direction), used to explicitly indicate the beam direction. For example, the beam indication information may include indication information of a reference signal associated with the beam direction or a beam direction identifier. The indication information of the reference signal associated with the beam direction includes, for example, an index of the reference signal representing the beam direction, for example, an SSB index or a CSI-RS index. The beam direction identifier may be, for example, an index or an identifier corresponding to the beam direction.

In another example, the first terminal apparatus may determine the beam direction based on the at least one of the RNTI, the CORESET, the search space, or the signaling format that is used to receive the first uplink grant information and that may correspond to the beam direction. For example, the at least one of the RNTI, the CORESET, the search space, or the signaling format used to receive the first uplink grant information may correspond to the beam direction. Therefore, after the first terminal apparatus receives the first uplink grant information, the beam direction corresponding to the at least one of the RNTI, the CORESET, the search space, or the signaling format may be used as the beam direction herein. In other words, the first uplink grant information may implicitly indicate the beam direction. Optionally, the first terminal apparatus may receive a third correspondence from the network device, where the third correspondence may include a correspondence between the beam direction and the at least one of the RNTI, the CORESET, the search space, or the signaling format used to receive the first uplink grant information. Alternatively, the third correspondence may be stored in the first terminal apparatus. For example, the correspondence may be pre-configured by the network device by using signaling, or may be defined in a protocol, or may be pre-configured in the first terminal apparatus. When receiving the first uplink grant information based on the at least one of the RNTI, the CORESET, the search space, or the signaling format, the first terminal apparatus may further determine the beam direction corresponding to the first uplink grant information, based on the third correspondence and the at least one of the RNTI, the CORESET, the search space, or the signaling format of the first uplink grant information.

For example, the third correspondence includes a correspondence between an RNTI-1 and an SSB-1 (or an index of an SSB-1), and includes a correspondence between an RNTI-2 and an SSB-2 (or an index of an SSB-2). When the first terminal apparatus receives the first uplink grant information based on the RNTI-1, the first terminal apparatus may use a beam direction associated with the SSB-1 as the beam direction, or use the SSB-1 as the beam direction. When the first terminal apparatus receives the first uplink grant information based on the RNTI-2, the first terminal apparatus may use a beam direction associated with the SSB-2 as the beam direction, or use the SSB-2 as the beam direction.
(2) In a second possible implementation, the first uplink grant information may be from the second terminal apparatus. For example, the second terminal apparatus may send the first uplink grant information to the first terminal apparatus based on second uplink grant information from the network device.

The second terminal apparatus may send the first uplink grant information to the first terminal apparatus in a unicast, groupcast, multicast, or broadcast manner through any communication link between terminals, for example, a D2D link, a sidelink, or BLUETOOTH. For example, the first uplink grant information may be carried on a physical sidelink control channel (PSCCH) or a physical sidelink shared channel (PSSCH).

In the second possible implementation, according to descriptions in this disclosure, optionally, the second terminal apparatus may send a scheduling request to the network device through a PUCCH, or the second terminal apparatus may send a buffer state to the network device through a PUSCH, and the second terminal apparatus may receive the second uplink grant information from the network device. The second terminal apparatus may determine the first uplink grant information based on the received second uplink grant information, and send the first uplink grant information to the first terminal apparatus. For example, the second terminal apparatus may determine a first time-frequency resource based on the second uplink grant information, and include indication information of the first time-frequency resource in the first uplink grant information.

The second terminal apparatus may determine, based on an explicit indication carried in the second uplink grant information, that the second uplink grant information is used by the second terminal apparatus to perform uplink data transmission. In other words, the second terminal apparatus may determine, based on the explicit indication carried in the second uplink grant information, that the second terminal apparatus is a primary terminal. In addition, in the second implementation, it is not excluded that the second terminal apparatus is a secondary terminal. For example, the first terminal apparatus and the second terminal apparatus are used as a group of secondary terminals, and the second terminal apparatus may be configured to forward the received uplink grant information to another secondary terminal (for example, including the first terminal apparatus).

In addition, in the second possible implementation, the first uplink grant information may further include a transmission resource (or indication information of the transmission resource) and/or a transmission parameter (or indication information of the transmission parameter) that are/is used by the first terminal apparatus to perform uplink transmission with the network device. Optionally, the second uplink grant information may include a transmission resource and/or a transmission parameter that are/is used by the second terminal apparatus to perform uplink transmission, and the transmission resource and/or the transmission parameter that are/is used by the first terminal apparatus to perform uplink transmission with the network device and that are/is in the first uplink grant information may be the same as the transmission resource and/or the transmission parameter that are/is used by the second terminal apparatus to perform uplink transmission and that are/is included in the second uplink grant information.

In a possible example, the first uplink grant information may include indication information of a transmission resource and/or a transmission parameter that are/is used and/or cannot be used by the first terminal apparatus to transmit the uplink data to the network device.

In the second possible implementation, the first uplink grant information may further include beam indication information. For example, the beam indication information may include indication information of a reference signal associated with a beam direction or a beam direction identifier. For details, refer to the descriptions of the beam indication information in the first implementation in this disclosure. The beam direction may be indicated by the second uplink grant information, and the second uplink grant information may explicitly or implicitly indicate the beam direction. For an explicit indication manner and an implicit indication manner, refer to manners of explicitly and implicitly indicating the beam direction in the first implementation.

It should be understood that in the implementations, in addition to the transmission resource and the transmission parameter, the first uplink grant information may further include other information used by the first terminal apparatus to perform uplink transmission. For example, the information includes an identifier of the primary terminal, an identifier of the secondary terminal, or indication information indicating whether the first terminal apparatus (or the secondary terminal) is allowed to perform uplink transmission by using the first uplink grant information (or the first time-frequency resource).

The identifier of the secondary terminal may explicitly indicate the secondary terminal. An identifier of the first terminal apparatus and/or the identifier of the secondary terminal are/is, for example, a UE ID, or may include other information that can be used to identify a terminal type, for example, information such as a first time-frequency resource or a DMRS resource or sequence corresponding to the terminal when the terminal can be identified by using the first time-frequency resource or the DMRS resource or sequence identifier. The terminal type in this disclosure indicates that the terminal is the primary terminal or the secondary terminal. Similarly, the identifier of the primary terminal may explicitly indicate the primary terminal (for example, the second terminal apparatus). The identifier of the primary terminal may be a UE ID of the terminal, or may include other information that can be used to identify the terminal. In addition, the identifier of the secondary terminal and the identifier of the primary terminal may also be used as an identifier of a terminal allowed to send data. If an identifier of a terminal receiving the first uplink grant information is not included in the identifier of the terminal allowed to send the data, it indicates that the terminal is not allowed to send the uplink data by using the first uplink grant information.

Optionally, in this disclosure, after receiving the first uplink grant information, the first terminal apparatus may determine, based on the first uplink grant information, that the first terminal apparatus is used as the secondary terminal. In addition, after receiving the first uplink grant information or the second uplink grant information, the second terminal apparatus may determine, based on the first uplink grant information or the second uplink grant information, that the second terminal apparatus is used as the primary terminal.

In this disclosure, when a terminal receives uplink grant information (including the first uplink grant information and/or the second uplink grant information), and the uplink grant information indicates only the primary terminal (for example, carries the identifier of the primary terminal), if the terminal determines that the terminal is not the primary terminal, for example, the identifier of the primary terminal does not include an identifier of the terminal, in an implementation, the terminal determines that the terminal is the secondary terminal, or if the terminal determines that the identifier of the primary terminal includes an identifier of the terminal, the terminal determines that the terminal is the primary terminal. Similarly, when a terminal receives uplink grant information (including the first uplink grant information and/or the second uplink grant information), and the uplink grant information indicates only the secondary terminal (for example, carries the identifier of the secondary terminal), if the terminal determines that the terminal is not the secondary terminal, for example, the identifier of the secondary terminal does not include an identifier of the terminal, in an implementation, the terminal determines that the terminal is the primary terminal, or if the terminal determines that the identifier of the secondary terminal includes an identifier of the terminal, the terminal determines that the terminal is the secondary terminal.

In addition, it should be understood that at least one of an RNTI, a CORESET, search space, or a signaling format used to receive the uplink grant information (including the first uplink grant information and/or the second uplink grant information) may correspond to the primary terminal or the secondary terminal, so that the terminal type can be implicitly indicated by using the uplink grant information. In an optional example, there is a correspondence (which may be referred to as a fourth correspondence) between the terminal type (for example, including the primary terminal and the secondary terminal) and the at least one of the RNTI, the CORESET, the search space, or the signaling format used to receive the first uplink grant information. For example, the network device configures two RNTIs: an RNTI-1 and an RNTI-2 for a terminal, and the two RNTIs are respectively associated with two types: the primary terminal and the secondary terminal. When the terminal receives a dynamic grant instruction by using the RNTI-1, the terminal determines that the terminal is the primary terminal. When the terminal receives a dynamic grant instruction by using the RNTI-2, the terminal determines that the terminal is the secondary terminal.

The first uplink grant information includes indication information used to indicate whether the first terminal apparatus (or the secondary terminal) is allowed to perform uplink transmission by using the first uplink grant information (or the first time-frequency resource). When the first uplink grant information includes indication information indicating that the first terminal apparatus (or the secondary terminal) is not allowed to perform uplink transmission by using the first uplink grant information (or the time-frequency resource), it is determined that the first uplink grant information is an invalid grant. When the first uplink grant information includes indication information indicating that the first terminal apparatus (or the secondary terminal) is allowed to perform uplink transmission by using the first uplink grant information (or the time-frequency resource), it is determined that the first uplink grant information is a valid grant. Details are as follows.

The indication information indicating whether the first terminal apparatus (or the secondary terminal) is allowed to perform uplink transmission by using the first uplink grant information (or the time-frequency resource) may include specific bit information in the first uplink grant information. For example, when a value of a specific bit in the first uplink grant information is “0”, it indicates indication information indicating that the first terminal apparatus (or the secondary terminal) is not allowed to perform uplink transmission by using the first uplink grant information (or the time-frequency resource). Correspondingly, the first terminal apparatus determines that the first uplink grant information is an invalid grant. When a value of a specific bit is “1”, it indicates indication information indicating that the first terminal apparatus (or the secondary terminal) is allowed to perform uplink transmission by using the first uplink grant information (or the time-frequency resource). Correspondingly, the first terminal apparatus determines that the first uplink grant information is a valid grant. For another example, when a value of a specific bit in the first uplink grant information is “0”, it indicates indication information indicating that the first terminal apparatus (or the secondary terminal) is allowed to perform uplink transmission by using the first uplink grant information (or the time-frequency resource). Correspondingly, the first terminal apparatus determines that the first uplink grant information is a valid grant. When a value of a specific bit is “1”, it indicates indication information indicating that the first terminal apparatus (or the secondary terminal) is not allowed to perform uplink transmission by using the first uplink grant information (or the time-frequency resource). Correspondingly, the first terminal apparatus determines that the first uplink grant information is an invalid grant. It may be understood that, in this disclosure, there is no specific requirement on a name of the indication information indicating that the first terminal apparatus (or the secondary terminal) is allowed to perform uplink transmission by using the first uplink grant information (or the time-frequency resource). The indication information may alternatively have another name, for example, indication information indicating whether the secondary terminal is allowed to perform transmission, or information indicating whether only the primary terminal performs transmission.

Optionally, when the first uplink grant information includes the identifier of the first terminal apparatus, or includes the indication information indicating that the first terminal apparatus is allowed to perform uplink transmission by using the first uplink grant information (or the first time-frequency resource), the first terminal apparatus may perform uplink data transmission based on the first uplink grant information. Otherwise, if the first uplink grant information does not include the identifier of the first terminal apparatus, or does not include the indication information indicating that the first terminal apparatus is allowed to perform uplink transmission by using the first time-frequency resource, the first terminal apparatus does not perform uplink transmission based on the first uplink grant information (or the first time-frequency resource). In other words, the first terminal apparatus ignores performing uplink transmission based on the first uplink grant information (or the first time-frequency resource).

That the first terminal apparatus obtains the first time-frequency resource includes that the first terminal apparatus obtains first indication information. The first indication information includes one or more of the following: information about a quantity of repeated transmissions of the second terminal apparatus, type information of repeated transmission of the second terminal apparatus, configuration information of the first time-frequency resource, frequency hopping type information, or frequency domain offset information for frequency hopping.

Further, the type information of repeated transmission may be, for example, slot-based repeated transmission, or mini-slot-based (a mini-slot may also be referred to as a sub-slot) repeated transmission. When the type information of repeated transmission is slot-based repeated transmission, each slot has only one TO resource, and TO time domain resources in different slots may be the same or may be different. When the type information of repeated transmission is mini-slot-based repeated transmission, a same slot may have a plurality of TO resources. The configuration information of the first time-frequency resource may include configuration information of a time domain resource in the first time-frequency resource and configuration information of a frequency domain resource in the first time-frequency resource. The frequency hopping type information may be, for example, inter-TO frequency hopping or intra-TO frequency hopping.

One or more items included in the first indication information may be configured by the network device for the first terminal apparatus. For example, when configuring a related parameter of uplink opportunistic transmission for the first terminal apparatus, the network device also configures the first indication information for the first terminal apparatus. For the related parameter of the uplink opportunistic transmission, refer to the related descriptions in step S901. The first indication information may also be carried in the first uplink grant information of the second terminal apparatus. Correspondingly, the first terminal apparatus may obtain the first indication information from the network device or the second terminal apparatus. When the first indication information includes a plurality of items, one part may be configured by the network device for the first terminal apparatus, and the other part may be obtained by the first terminal apparatus from the first uplink grant information of the second terminal apparatus. For example, the first indication information includes the information about the quantity of repeated transmissions of the second terminal apparatus, the type information of repeated transmission of the second terminal apparatus, the configuration information of the first time-frequency resource, the frequency hopping type information, and the frequency domain offset information for frequency hopping. The information about the quantity of repeated transmissions of the second terminal apparatus, the type information of repeated transmission of the second terminal apparatus, and the frequency domain offset information for frequency hopping are configured by the network device for the first terminal apparatus. The configuration information of the first time-frequency resource and the frequency hopping type information are obtained by the first terminal apparatus from the first uplink grant information of the second terminal apparatus.

The first indication information may be understood as configuration information. The first terminal apparatus may determine the first time-frequency resource based on the first indication information. Details may be further as follows. For example, the first indication information includes the information about the quantity of repeated transmissions of the second terminal apparatus, the type information of repeated transmission of the second terminal apparatus, the configuration information of the first time-frequency resource, the frequency hopping type information, and the frequency domain offset information for frequency hopping. The first terminal apparatus determines a quantity of TOs based on the information about the quantity of repeated transmissions, determines a frequency domain resource of each TO based on the configuration information of the frequency domain resource in the first time-frequency resource, the frequency hopping type information, and the frequency domain offset information for frequency hopping, and determines a time domain resource of each TO based on the configuration information of the time domain resource in the first time-frequency resource and the type information of repeated transmission. The frequency domain resource of each TO and the time domain resource of each TO may be understood as the first time-frequency resource.

It should be noted that, in this embodiment of this disclosure, the first terminal apparatus may be an mMTC apparatus or a chip in an mMTC apparatus, or may be a URLLC apparatus or a chip in a URLLC apparatus, and the second terminal apparatus may be an eMBB apparatus or a chip in an eMBB apparatus.

S1102: The first terminal apparatus sends second uplink data on a second time-frequency resource.

The second time-frequency resource is a part of the first time-frequency resource. Optionally, before the first terminal apparatus sends the second uplink data on the second time-frequency resource, the first terminal apparatus determines the second time-frequency resource. That the first terminal apparatus determines the second time-frequency resource includes two aspects. The two aspects are as follows.

In a first aspect, when the second terminal apparatus repeatedly transmits the first uplink data, optionally, the second terminal apparatus may or may not support a frequency hopping transmission manner, and the first terminal apparatus determines the second time-frequency resource in the following two manners. The two manners are as follows.

Manner A: The first terminal apparatus receives the second indication information, and determines the second time-frequency resource based on the second indication information. When the first time-frequency resource includes a plurality of resources used by the second terminal apparatus to repeatedly transmit the first uplink data, the second indication information includes one or more of the following: resource index information of the second time-frequency resource and RV information related to the second time-frequency resource.

The resource index information of the second time-frequency resource may be understood as a TO index, for example, may be a specific number of a TO in the first time-frequency resource. In an example, the first time-frequency resource includes four TOs, the second indication information includes the index information of the second time-frequency resource, and the index information of the second time-frequency resource is a 1^{st} TO and a 2^{nd} TO. Correspondingly, the first terminal apparatus may determine, based on the second indication information, that the second time-frequency resource is the 1^{st} TO and the 2^{nd} TO in the four TOs.

When there is an association relationship between the second time-frequency resource and an RV used by the second terminal device to perform repeated transmission, the second indication information may include the RV information related to the second time-frequency resource. Correspondingly, the first terminal apparatus may determine the second time-frequency resource based on the RV information related to the second time-frequency resource. In an example, the first time-frequency resource includes four TOs, RVs corresponding to the four TOs are respectively an RV 0, an RV 2, an RV 3, and an RV 1, and the second indication information includes the RV information related to the second time-frequency resource. The RV information related to the second time-frequency resource may be the RV 3. Correspondingly, the first terminal apparatus may determine, based on the second indication information, that the second time-frequency resource is a 3^{rd} TO in the four TOs.

When a same RV is associated with a plurality of TOs, the second indication information includes the resource index information of the second time-frequency resource and the RV information related to the second time-frequency resource. In an example, the first time-frequency resource includes eight TOs, and RVs corresponding to the eight TOs are an RV 0, an RV 2, an RV 3, an RV 1, an RV 0, an RV 2, an RV 3, and an RV 1. The second indication information includes the resource index information of the second time-frequency resource and the RV information related to the second time-frequency resource. The resource index information of the second time-frequency resource may be the 1^{st}. The RV information related to the second time-frequency resource may be the RV 0. In other words, the second indication information indicates a TO corresponding to the 1^{st} RV 0. Correspondingly, the first terminal apparatus may determine, based on the second indication information, that the second time-frequency resource is the 1^{st} TO in the eight TOs.

Optionally, the second indication information may be sent by the network device by using an RRC message, a MAC CE, or DCI. For example, when configuring a related parameter of uplink opportunistic transmission for the first terminal apparatus, the network device may also configure the second indication information for the first terminal apparatus.

It should be noted that, if the first terminal apparatus also needs to perform repeated transmission, optionally, the first terminal apparatus determines a TO used for first repeated transmission, that is, the second time-frequency resource. A subsequent TO, that is, a third time-frequency resource may be used for subsequent repeated transmission. A time domain resource in the third time-frequency resource is located after a time domain resource in the second time-frequency resource. The first terminal apparatus may also directly determine, based on the foregoing method, all TO resources used for repeated transmission.

Manner B: The first terminal apparatus determines the second time-frequency resource by itself.

For example, the first terminal apparatus may randomly select a part of the first time-frequency resource as the second time-frequency resource. In an example, the first time-frequency resource includes four TOs, and the first terminal apparatus may randomly select a 1^{st} TO and a 3^{rd} TO in the four TOs as the second time-frequency resource. Certainly, in addition to the random selection manner, the first terminal apparatus may also select a part of the first time-frequency resource as the second time-frequency resource according to a predefined rule. Another selection manner may alternatively be used. This is not limited in this embodiment of this disclosure.

For another example, the first terminal apparatus may determine the second time-frequency resource based on identification information of the first terminal apparatus. The identification information of the first terminal apparatus may be an RNTI, or a temporary identifier or an index configured by the network device for the first terminal apparatus. This is not limited in this embodiment of this disclosure.

In a possible implementation, after the first terminal apparatus determines the second time-frequency resource, the first terminal apparatus may send fifth indication information to the network device. The fifth indication information is used to indicate the first terminal apparatus to use the second time-frequency resource to send the second uplink data, that is, notify the network device that the time-frequency resource used when the first terminal apparatus sends the second uplink data is the second time-frequency resource. The fifth indication information may include at least one of the following: the resource index information of the second time-frequency resource and the RV information related to the second time-frequency resource. The fifth indication information may be sent by the first terminal apparatus by using an RRC message, a MAC CE, or DCI, or may be sent by sending a sequence. There is a relationship between the sequence and the second time-frequency resource. Correspondingly, the network device may determine based on the sequence that a resource used by the first terminal apparatus to send the second uplink data is the second time-frequency resource. It should be noted that the first terminal apparatus may directly send the fifth indication information to the network device, or may first send the fifth indication information to the second terminal apparatus, and then the second terminal apparatus sends the fifth indication information to the network device. The fifth indication information may be sent by the second terminal apparatus by using an RRC message, a MAC CE, or DCI, or may be sent by sending a sequence.

In a possible implementation, the first terminal apparatus receives sixth indication information, determines an available TO resource pool based on the sixth indication information, and determines, from the available TO resource pool, the second time-frequency resource used to transmit the second uplink data. The available TO resource pool may be the first time-frequency resource or a part of the first time-frequency resource. In an example, the sixth indication information indicates that there are eight TOs in the available resource pool, and first four TOs are unavailable. The first terminal apparatus selects, by itself based on the sixth indication information, an available TO from last four TOs in the eight TOs as the second time-frequency resource. For example, the available TO may be randomly selected, or selected according to a specific rule. A selection manner is not limited. Optionally, the sixth indication information may indicate index information of an available or unavailable TO. When the second time-frequency resource has an association relationship with the RV used by the second terminal device to perform repeated transmission, the sixth indication information may indicate information about an available or unavailable RV. The sixth indication information may be sent by the network device to the first terminal apparatus by using an RRC message, a MAC CE, or DCI. For example, when the network device configures a related parameter of uplink opportunistic transmission for the first terminal apparatus, the sixth indication information may also be configured for the first terminal apparatus, or may be first sent by the network device to the second terminal apparatus, and then sent by the second terminal apparatus to the first terminal apparatus by using an RRC message, a MAC CE, or DCI.

In a second aspect, when the second terminal apparatus transmits the first uplink data in a frequency hopping transmission manner, as shown in FIG. 12, FIG. 12 is a diagram of frequency hopping transmission according to this disclosure. The network device schedules the second terminal apparatus by using the first uplink grant information, to send the first uplink data on K symbols in a specific slot, where K is a positive integer greater than 1. A frequency domain resource used by a first hop (for example, first └K/2┘ symbols) is different from (does not overlap or does not completely overlay) a frequency domain resource used by a second hop (for example, last K−└K/2┘ symbols, where └┘ represents rounding down). For example, an index of a start resource block of the frequency domain resource of the first hop is RB_1, and an index of a start resource block of the frequency domain resource of the second hop is RB_2, where RB_2=(RB_1+RB_offset) mod RB_BWP, RB_offset is a resource block offset value that is configured by the network device for the second terminal apparatus and that is used to calculate the frequency domain resource used by the second hop, and RB_BWP is a total quantity of resource blocks included in a bandwidth part. In other words, it may be understood that the first time-frequency resource includes a time-frequency resource of the first hop and a time-frequency resource of the second hop. The frequency domain resource in the time-frequency resource of the first hop does not overlap the frequency domain resource in the time-frequency resource of the second hop. The first terminal apparatus determines the second time-frequency resource in the following two manners. The two manners are as follows.

Manner C: The first terminal apparatus receives third indication information, and determines the second time-frequency resource based on the third indication information.

The third indication information includes frequency hopping index information of the first hop or frequency hopping index information of the second hop. The second time-frequency resource includes the time-frequency resource of the first hop or the time-frequency resource of the second hop. In an example, the frequency hopping index information that is of the first hop and that is included in the third indication information is the first hop, and the first terminal apparatus determines the second time-frequency resource based on the third indication information. The second time-frequency resource is the time-frequency resource of the first hop. The third indication information may be sent by the network device to the first terminal apparatus by using an RRC message, a MAC CE, or DCI. For example, when configuring a related parameter of uplink opportunistic transmission for the first terminal apparatus, the network device may also configure the third indication information for the first terminal apparatus.

Manner D: The first terminal apparatus determines the second time-frequency resource by itself.

For example, the first terminal apparatus randomly selects a time-frequency resource of the first hop or a time-frequency resource of the second hop as the second time-frequency resource. Certainly, in addition to the random selection manner, the first terminal apparatus may also perform selection according to a predefined rule. Another selection manner may alternatively be used. This is not limited in this embodiment of this disclosure.

For example, the first terminal apparatus determines the second time-frequency resource based on the identification information of the first terminal apparatus. The second time-frequency resource includes the time-frequency resource of the first hop or the time-frequency resource of the second hop. The identification information of the first terminal apparatus may be an RNTI, or a temporary identifier or an index configured by the network device for the first terminal apparatus. This is not limited in this embodiment of this disclosure.

Optionally, after the first terminal apparatus determines the second time-frequency resource, the first terminal apparatus may send seventh indication information to the network device. The seventh indication information is used to indicate the first terminal apparatus to use the second time-frequency resource to send the second uplink data, that is, notify the network device that the time-frequency resource used when the first terminal apparatus sends the second uplink data is the second time-frequency resource. The seventh indication information may include the frequency hopping index information of the first hop or the frequency hopping index information of the second hop. The seventh indication information may be sent by the first terminal apparatus by using an RRC message, a MAC CE, or DCI, or may be sent by sending a sequence. There is a relationship between the sequence and the second time-frequency resource. Correspondingly, the network device may determine based on the sequence that a resource used by the first terminal apparatus to send the second uplink data is the second time-frequency resource. It should be noted that the first terminal apparatus may directly send the seventh indication information to the network device, or may first send the seventh indication information to the second terminal apparatus, and then the second terminal apparatus sends the seventh indication information to the network device. The seventh indication information may be sent by the second terminal apparatus by using an RRC message, a MAC CE, or DCI, or may be sent by sending a sequence.

Optionally, the first terminal apparatus may further determine based on the first information whether to use the first time-frequency resource to perform affiliated transmission or use the second time-frequency resource to perform affiliated transmission. The first time-frequency resource includes the time-frequency resource of the first hop and the time-frequency resource of the second hop. The first information includes one or more of the following: a volume of transmitted data of the first terminal apparatus, an MCS of the first terminal apparatus, a size of the time-frequency resource of the first hop, or a size of the time-frequency resource of the second hop. In an example, if the first terminal apparatus determines that the size of the time-frequency resource of the first hop and the configured MCS can be used to transmit all the transmitted data, the first terminal apparatus determines to perform affiliated transmission by using the size of the time-frequency resource of the first hop, or otherwise, the first terminal apparatus performs affiliated transmission by using the first time-frequency resource.

In a possible implementation, after the first terminal apparatus determines the second time-frequency resource, the first terminal apparatus may send fourth indication information to the network device. The fourth indication information indicates that the first terminal apparatus uses the second time-frequency resource to send the second uplink data, that is, notify the network device that the time-frequency resource used when the first terminal apparatus sends the second uplink data is the second time-frequency resource. The fourth indication information may include one or more of the following: the resource index information of the second time-frequency resource, the RV information related to the second time-frequency resource, the frequency hopping index information of the first hop, or the frequency hopping index information of the second hop. It should be noted that the first terminal apparatus may directly send the fourth indication information to the network device, or may first send the fourth indication information to the second terminal apparatus, and then the second terminal apparatus sends the fourth indication information to the network device. The fourth indication information may be sent by the second terminal apparatus by using an RRC message, a MAC CE, or DCI.

In a possible implementation, after determining the second time-frequency resource, the first terminal apparatus determines a resource that is in the second time-frequency resource and that is to be canceled (or omit) or not expected in transmission. When a first condition is met, the first terminal apparatus cancels sending of the second uplink data on a part or all of the second time-frequency resource. The first condition includes one or more of the following: the second time-frequency resource includes a symbol that is unavailable to the first terminal apparatus, or transmission of the second terminal apparatus on the second time-frequency resource is canceled. The first condition may further include that a processing time of the first terminal apparatus does not meet a preset requirement.

The second time-frequency resource includes the symbol that is unavailable to the first terminal apparatus, for example, a downlink symbol. That transmission of the second terminal apparatus on the second time-frequency resource is canceled includes, when first-priority service data needs to be sent on a part or all of a time domain resource in the second time-frequency resource, transmission of the second terminal apparatus on the second time-frequency resource is canceled, where a priority of the first-priority service data is higher than a priority of the first uplink data, or when a frequency domain resource used for transmitting first-priority service data overlaps the frequency domain resource in the second time-frequency resource, transmission of the second terminal apparatus on the second time-frequency resource is canceled, where a priority of the first-priority service data is higher than a priority of the first uplink data.

When the first-priority service data needs to be sent on a part or all of a time domain resource in the second time-frequency resource, transmission of the second terminal apparatus on the second time-frequency resource is canceled. The priority of the first-priority service data is higher than the priority of the first uplink data. It may be understood that when a high-priority service or signal needs to be sent on a time domain resource that overlaps the second time-frequency resource, a grant of the second terminal apparatus on the second time-frequency resource is deprioritized. Correspondingly, the second terminal apparatus does not send data on the second time-frequency resource based on the first uplink grant information, and transmission of the second terminal apparatus on the second time-frequency resource is canceled. Correspondingly, transmission of the first terminal apparatus on the second time-frequency resource is also canceled.

When a frequency domain resource used for transmitting the first-priority service data overlaps the frequency domain resource in the second time-frequency resource, transmission of the second terminal apparatus on the second time-frequency resource is canceled. The priority of the first-priority service data is higher than the priority of the first uplink data. It may be understood that, when a frequency domain resource used for transmitting a high-priority service or signal overlaps the frequency domain resource in the second time-frequency resource, transmission of the second terminal apparatus on the second time-frequency resource is canceled, and correspondingly, transmission of the first terminal apparatus on the second time-frequency resource is also canceled. When a frequency domain resource used for transmitting a high-priority service or signal does not overlap the frequency domain resource in the second time-frequency resource, the first terminal apparatus may send the first uplink data on the second time-frequency resource.

A processing time of the first terminal apparatus does not meet a preset requirement. For example, if the first terminal apparatus has not prepared, before the second time-frequency resource arrives, the second uplink data that needs to be transmitted, it may be understood that the processing time of the first terminal apparatus does not meet the requirement.

The foregoing describes the method provided in embodiments of this disclosure. To implement functions in the method provided in the foregoing embodiments of this disclosure, a communication apparatus may include a hardware structure and/or a software module, to implement the foregoing functions by using the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

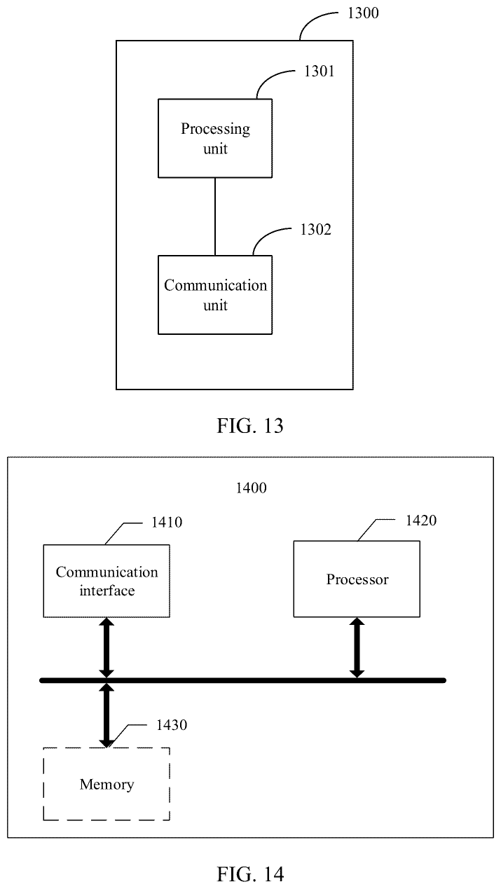

Refer to FIG. 13. FIG. 13 is a diagram of a structure of a data transmission apparatus according to this disclosure. Based on a same technical concept, an embodiment of this disclosure further provides a data transmission apparatus 1300. The data transmission apparatus 1300 may be a data transmission apparatus, an apparatus or a component in a data transmission apparatus, or an apparatus that can be used with a data transmission apparatus in a matching manner. The data transmission apparatus 1300 may be a terminal device or a network device. In a design, the data transmission apparatus 1300 may include a one-to-one corresponding module for performing the method/operation/step/action in the foregoing method embodiments. The module may be a hardware circuit or software, or may be implemented by a combination of a hardware circuit and software. In a design, the data transmission apparatus 1300 may include a processing unit 1301 and a communication unit 1302. The communication unit 1302 may include a sending module and/or a receiving module.

For example, when the apparatus is configured to perform the method that is performed by the first terminal apparatus and that is described in the foregoing embodiments, the apparatus may include the communication unit 1302 and the processing unit 1301. The processing unit 1301 is configured to obtain a first time-frequency resource. The first time-frequency resource is used by a second terminal apparatus to transmit first uplink data. The first time-frequency resource is determined based on first uplink grant information of the second terminal apparatus. The communication unit 1302 is configured to send second uplink data on a second time-frequency resource. The second time-frequency resource is a part of the first time-frequency resource.

In a possible implementation, the processing unit 1301 is configured to obtain first indication information. The first indication information includes one or more of the following: information about a quantity of repeated transmissions of the second terminal apparatus, type information of repeated transmission of the second terminal apparatus, configuration information of the first time-frequency resource, frequency hopping type information, or frequency domain offset information for frequency hopping.

In still another possible implementation, the communication unit 1302 is further configured to receive second indication information. When the first time-frequency resource includes a plurality of resources used by the second terminal apparatus to repeatedly transmit the first uplink data, the second indication information includes one or more of the following: resource index information of the second time-frequency resource and RV information related to the second time-frequency resource. The processing unit 1301 is further configured to determine the second time-frequency resource based on the second indication information.

In still another possible implementation, the processing unit 1301 is further configured to randomly select a part of the first time-frequency resource as the second time-frequency resource, or the processing unit 1301 is further configured to determine the second time-frequency resource based on identification information of the first terminal apparatus.

In still another possible implementation, when the second terminal apparatus transmits the first uplink data in a frequency hopping transmission manner, the first time-frequency resource includes a time-frequency resource of a first hop and a time-frequency resource of a second hop, where a frequency domain resource in the time-frequency resource of the first hop does not overlap a frequency domain resource in the time-frequency resource of the second hop. The communication unit 1302 is further configured to receive third indication information, where the third indication information includes frequency hopping index information of the first hop or frequency hopping index information of the second hop. The processing unit 1301 is further configured to determine the second time-frequency resource based on the third indication information, where the second time-frequency resource includes the time-frequency resource of the first hop or the time-frequency resource of the second hop.

In still another possible implementation, when the second terminal apparatus transmits the first uplink data in a frequency hopping transmission manner, the first time-frequency resource includes a time-frequency resource of a first hop and a time-frequency resource of a second hop, where a frequency domain resource in the time-frequency resource of the first hop does not overlap a frequency domain resource in the time-frequency resource of the second hop. The processing unit 1301 is further configured to randomly select a time-frequency resource of the first hop or a time-frequency resource of the second hop as the second time-frequency resource, or the processing unit 1301 is further configured to determine the second time-frequency resource based on identification information of the first terminal apparatus, where the second time-frequency resource includes a time-frequency resource of the first hop or a time-frequency resource of the second hop.

In still another possible implementation, the communication unit 1302 is further configured to send fourth indication information, where the fourth indication information is used to use the second time-frequency resource to send the second uplink data.

In still another possible implementation, the processing unit 1301 is further configured to, when a first condition is met, cancel sending of the second uplink data on a part or all of the second time-frequency resource. The first condition includes one or more of the following: the second time-frequency resource includes a symbol that is unavailable to the first terminal apparatus, or transmission of the second terminal apparatus on the second time-frequency resource is canceled.

In still another possible implementation, when first-priority service data needs to be sent on a part or all of a time domain resource in the second time-frequency resource, transmission of the second terminal apparatus on the second time-frequency resource is canceled, where a priority of the first-priority service data is higher than a priority of the first uplink data, or when a frequency domain resource used for transmitting first-priority service data overlaps a frequency domain resource in the second time-frequency resource, transmission of the second terminal apparatus on the second time-frequency resource is canceled, where a priority of the first-priority service data is higher than a priority of the first uplink data.

In still another possible implementation, the data transmission apparatus is an mMTC apparatus, and the second terminal apparatus is an eMBB apparatus.

For example, when the apparatus is configured to perform the method that is performed by the network device and that is described in the foregoing embodiments, the apparatus may include the communication unit 1302 and the processing unit 1301. The processing unit 1301 is configured to determine first uplink grant information. The communication unit 1302 is configured to send the first uplink grant information. The first uplink grant information is used for determining a first time-frequency resource. The first time-frequency resource is used by a second terminal apparatus to transmit first uplink data. The communication unit 1302 is configured to receive second uplink data on a second time-frequency resource. The second time-frequency resource is a part of the first time-frequency resource. For the first uplink grant information, refer to the descriptions of the first uplink grant information in the foregoing method embodiments.

The communication unit 1302 may be further configured to perform an action represented by using an arrow in the embodiment shown in FIG. 11. The processing unit 1301 is further configured to perform another operation in the action represented by using a rectangular box in the embodiment shown in FIG. 11.

Division into the modules in embodiments of this disclosure is an example, is merely division into logical functions, and may be other division during actual implementation. In addition, functional modules in embodiments of this disclosure may be integrated into one processor, or each of the modules may exist alone physically, or two or more modules may be integrated into one module. The integrated module may be implemented in a form of hardware, or may be implemented in a form of a software functional module.

Refer to FIG. 14. FIG. 14 is a diagram of a structure of another data transmission apparatus according to this disclosure. The apparatus is configured to implement the data transmission method provided in this disclosure. The data transmission apparatus 1400 may be an apparatus or a component in a terminal device, may be a terminal device, or may be a network device or an apparatus or a component in a network device. The data transmission apparatus 1400 may be a data transmission apparatus, an apparatus in a data transmission apparatus, or an apparatus that can be used with a data transmission apparatus in a matching manner. The data transmission apparatus 1400 may be a chip system or a chip. In this embodiment of this disclosure, the chip system may include a chip, or may include a chip and another discrete component. The data transmission apparatus 1400 includes at least one processor 1420 configured to implement the data transmission method provided in embodiments of this disclosure. The data transmission apparatus 1400 may further include a communication interface 1410. The communication interface 1410 may also be referred to as an input/output interface. In this embodiment of this disclosure, the communication interface 1410 is configured to communicate with another apparatus by using a transmission medium. For example, when the data transmission apparatus 1400 is a chip, the data transmission apparatus 1400 performs transmission with another chip or component through the communication interface 1410. The processor 1420 may be configured to implement the method described in the foregoing method embodiments.

For example, when the apparatus is configured to perform the method that is performed by the first terminal apparatus and that is described in the foregoing embodiments, the apparatus may include the communication interface 1410 and the processor 1420. The processor 1420 is configured to perform the following operations: obtaining a first time-frequency resource, where the first time-frequency resource is used by a second terminal apparatus to transmit first uplink data, and the first time-frequency resource is determined based on first uplink grant information of the second terminal apparatus, and sending second uplink data on a second time-frequency resource by using the communication interface 1410, where the second time-frequency resource is a part of the first time-frequency resource.

In a possible implementation, the processor 1420 is configured to obtain first indication information. The first indication information includes one or more of the following: information about a quantity of repeated transmissions of the second terminal apparatus, type information of repeated transmission of the second terminal apparatus, configuration information of the first time-frequency resource, frequency hopping type information, or frequency domain offset information for frequency hopping.

In still another possible implementation, the processor 1420 is further configured to receive second indication information by using the communication interface 1410. When the first time-frequency resource includes a plurality of resources used by the second terminal apparatus to repeatedly transmit the first uplink data, the second indication information includes one or more of the following: resource index information of the second time-frequency resource and RV information related to the second time-frequency resource. The processor 1420 is further configured to determine the second time-frequency resource based on the second indication information.

In still another possible implementation, the processor 1420 is further configured to randomly select a part of the first time-frequency resource as the second time-frequency resource, or the processor 1420 is further configured to determine the second time-frequency resource based on identification information of the first terminal apparatus.

In still another possible implementation, when the second terminal apparatus transmits the first uplink data in a frequency hopping transmission manner, the first time-frequency resource includes a time-frequency resource of a first hop and a time-frequency resource of a second hop, where a frequency domain resource in the time-frequency resource of the first hop does not overlap a frequency domain resource in the time-frequency resource of the second hop. The processor 1420 is further configured to receive third indication information by using the communication interface 1410, where the third indication information includes frequency hopping index information of the first hop or frequency hopping index information of the second hop. The processor 1420 is further configured to determine the second time-frequency resource based on the third indication information, where the second time-frequency resource includes the time-frequency resource of the first hop or the time-frequency resource of the second hop.

In still another possible implementation, when the second terminal apparatus transmits the first uplink data in a frequency hopping transmission manner, the first time-frequency resource includes a time-frequency resource of a first hop and a time-frequency resource of a second hop, where a frequency domain resource in the time-frequency resource of the first hop does not overlap a frequency domain resource in the time-frequency resource of the second hop. The processor 1420 is further configured to randomly select a time-frequency resource of the first hop or a time-frequency resource of the second hop as the second time-frequency resource, or the processor 1420 is further configured to determine the second time-frequency resource based on identification information of the first terminal apparatus, where the second time-frequency resource includes a time-frequency resource of the first hop or a time-frequency resource of the second hop.

In still another possible implementation, the processor 1420 is further configured to send fourth indication information by using the communication interface 1410, where the fourth indication information indicates that the second time-frequency resource is used to send the second uplink data.

In still another possible implementation, the processor 1420 is further configured to, when a first condition is met, cancel sending of the second uplink data on a part or all of the second time-frequency resource. The first condition includes one or more of the following: the second time-frequency resource includes a symbol that is unavailable to the first terminal apparatus, or transmission of the second terminal apparatus on the second time-frequency resource is canceled.

In still another possible implementation, when first-priority service data needs to be sent on a part or all of a time domain resource in the second time-frequency resource, transmission of the second terminal apparatus on the second time-frequency resource is canceled, where a priority of the first-priority service data is higher than a priority of the first uplink data, or when a frequency domain resource used for transmitting first-priority service data overlaps a frequency domain resource in the second time-frequency resource, transmission of the second terminal apparatus on the second time-frequency resource is canceled, where a priority of the first-priority service data is higher than a priority of the first uplink data.

In still another possible implementation, the data transmission apparatus is an mMTC apparatus, and the second terminal apparatus is an eMBB apparatus.

For example, when the apparatus is configured to perform the method that is performed by the network device and that is described in the foregoing embodiments, the apparatus may include the communication interface 1410 and the processor 1420. The processor 1420 is configured to determine first uplink grant information. The processor 1420 is configured to send the first uplink grant information by using the communication interface 1410. The first uplink grant information is used for determining a first time-frequency resource. The first time-frequency resource is used by a second terminal apparatus to transmit first uplink data. The processor 1420 is configured to receive second uplink data on a second time-frequency resource by using the communication interface 1410. The second time-frequency resource is a part of the first time-frequency resource. For the first uplink grant information, refer to the descriptions in the foregoing method embodiments.

The communication interface 1410 may be further configured to perform an action represented by using an arrow in the embodiment shown in FIG. 11. The processor 1420 is further configured to perform another operation in the action represented by using a rectangular box in the embodiment shown in FIG. 11.

The data transmission apparatus 1400 may further include at least one memory 1430 configured to store program instructions and/or data. The memory 1430 is coupled to the processor 1420. The coupling in this embodiment of this disclosure may be an indirect coupling or a communication connection between apparatuses, units, or modules in an electrical form, a mechanical form, or another form, and is used for information exchange between the apparatuses, the units, or the modules. The processor 1420 may operate with the memory 1430 together. The processor 1420 may execute the program instructions stored in the memory 1430. At least one of the at least one memory may be integrated with the processor.

In this embodiment of this disclosure, the memory 1430 may be a non-volatile memory such as a hard disk drive (HDD) or a solid-state drive (SSD), or may be a volatile memory such as a random-access memory (RAM). The memory is any other medium that can carry or store expected program code in a form of an instruction or a data structure and that can be accessed by a computer, but is not limited thereto. The memory in embodiments of this disclosure may alternatively be a circuit or any other apparatus that can implement a storage function, and is configured to store the program instructions and/or the data.

In this embodiment of this disclosure, the processor 1420 may be a general-purpose processor, a digital signal processor, an application-specific integrated circuit, a field programmable gate array or another programmable logic device, a discrete gate or a transistor logic device, or a discrete hardware component, and may implement or perform the methods, steps, and logical block diagrams disclosed in embodiments of this disclosure. The general-purpose processor may be a microprocessor or any other processor or the like. The steps of the method disclosed with reference to embodiments of this disclosure may be directly performed by a hardware processor, or may be performed by using a combination of hardware in the processor and a software module.

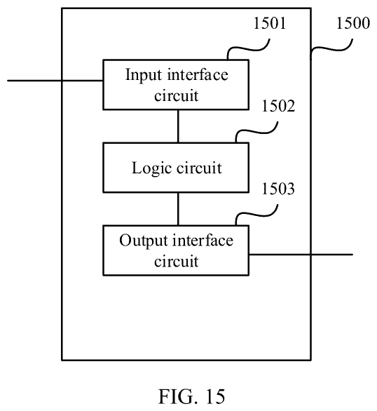

Refer to FIG. 15. FIG. 15 is a diagram of a structure of another data transmission apparatus 1500 according to this disclosure. The apparatus is configured to implement the data transmission method provided in this disclosure. The data transmission apparatus 1500 may be an apparatus in a terminal device, may be a terminal device, or may be a network device or an apparatus or a component in a network device. The data transmission apparatus 1500 may be a data transmission apparatus, an apparatus in a data transmission apparatus, or an apparatus that can be used with a data transmission apparatus in a matching manner. The data transmission apparatus 1500 may be a chip system or a chip. In this embodiment of this disclosure, the chip system may include a chip, or may include a chip and another discrete component. A part or all of the data transmission method provided in the foregoing embodiments may be implemented by hardware or software. When the data transmission method is implemented by hardware, the data transmission apparatus 1500 may include an input interface circuit 1501, a logic circuit 1502, and an output interface circuit 1503. Optionally, that the apparatus is configured to implement a function of a first terminal apparatus is used as an example. The input interface circuit 1501 may be configured to obtain first uplink grant information, the logic circuit 1502 may be configured to perform a processing action of the first terminal apparatus, and the output interface circuit 1503 may be configured to output uplink data.

Optionally, during specific implementation, the data transmission apparatus 1500 may be a chip or an integrated circuit.

Some or all of operations and functions performed by the data transmission apparatus described in the foregoing method embodiments of this disclosure may be implemented by using the chip or the integrated circuit.

An embodiment of this disclosure provides a computer-readable storage medium. The computer-readable storage medium includes computer program code. When the computer program code is run on a computer, the computer is enabled to perform the foregoing method embodiments.

An embodiment of this disclosure provides a computer program product. The computer program product includes computer program code. When the computer program code is run on a computer, the computer is enabled to perform the foregoing method embodiments.

Persons skilled in the art should understand that embodiments of this disclosure may be provided as a method, a system, or a computer program product. Therefore, this disclosure may use a form of hardware-only embodiments, software-only embodiments, or embodiments with a combination of software and hardware. In addition, this disclosure may use a form of a computer program product that is implemented on one or more computer-usable storage media (including but not limited to a disk memory, a compact disc (CD) read-only memory (ROM) (CD-ROM), an optical memory, and the like) that include computer-usable program code.

This disclosure is described with reference to the flowcharts and/or block diagrams of the method, the device (system), and the computer program product according to embodiments of this disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions can alternatively be loaded onto a computer or another programmable data processing device, so that a series of operations and steps are performed on the computer or the other programmable device to generate computer-implemented processing. Therefore, the instructions executed on the computer or the other programmable device provide steps for implementing a specific function in one or more procedures in the flowcharts and/or in one or more blocks in the block diagrams.

Although embodiments of this disclosure are described, persons skilled in the art can make changes and modifications to these embodiments after they learn of a basic concept. Therefore, the following claims are intended to be construed as to cover the embodiments and all changes and modifications falling within the scope of this disclosure.

It is clear that persons skilled in the art may make various modifications and variations to embodiments of this disclosure without departing from the scope of embodiments of this disclosure. In this case, this disclosure is intended to cover these modifications and variations of embodiments of this disclosure provided that they fall within the scope of protection defined by the following claims and their equivalent technologies.

1. A method implemented by a first terminal apparatus, wherein the method comprises:
obtaining a first time-frequency resource configured for a second terminal apparatus to transmit first uplink data, wherein the first time-frequency resource is based on first uplink grant information of the second terminal apparatus; and
sending, on a second time-frequency resource, second uplink data,
wherein the second time-frequency resource is a part of the first time-frequency resource.

2. The method of claim 1, wherein obtaining the first time-frequency resource comprises obtaining indication information, and wherein the indication information comprises one or more of:
first information about a quantity of repeated transmissions of the second terminal apparatus;
type information of repeated transmission of the second terminal apparatus;
configuration information of the first time-frequency resource;
frequency hopping type information; or
frequency domain offset information for frequency hopping.

3. The method of claim 1, wherein the first time-frequency resource comprises resources for the second terminal apparatus to repeatedly transmit the first uplink data, and wherein the method further comprises:
receiving indication information, wherein the indication information comprises one or more of resource index information of the second time-frequency resource or redundancy version (RV) information related to the second time-frequency resource; and
determining, based on the indication information, the second time-frequency resource.

4. The method of claim 1, further comprising:
randomly selecting the part of the first time-frequency resource as the second time-frequency resource; or
determining, based on identification information of the first terminal apparatus, the second time-frequency resource.

5. The method of claim 1, wherein the first time-frequency resource comprises a third time-frequency resource of a first hop and a fourth time-frequency resource of a second hop, wherein a first frequency domain resource in the third time-frequency resource does not overlap a second frequency domain resource in the fourth time-frequency resource, and wherein the method further comprises:
receiving indication information comprising first frequency hopping index information of the first hop or second frequency hopping index information of the second hop; and
determining, based on the indication information, the second time-frequency resource, wherein the second time-frequency resource comprises the third time-frequency resource or the fourth time-frequency resource.

6. The method of claim 1, wherein the first time-frequency resource comprises a third time-frequency resource of a first hop and a fourth time-frequency resource of a second hop, wherein a first frequency domain resource in the third time-frequency resource does not overlap a second frequency domain resource in the fourth time-frequency resource, and wherein the method further comprises:
randomly selecting the third time-frequency resource or the fourth time-frequency resource as the second time-frequency resource; or
determining, based on identification information of the first terminal apparatus, the second time-frequency resource, wherein the second time-frequency resource comprises the third time-frequency resource or the fourth time-frequency resource.

7. The method of claim 1, further comprising sending indication information indicating that the first terminal apparatus uses the second time-frequency resource to send the second uplink data.

8. The method of claim 1, further comprising canceling sending of the second uplink data on the second time-frequency resource when a first condition is met, wherein the first condition comprises one or more of the following:
the second time-frequency resource comprises a symbol that is unavailable to the first terminal apparatus; or
transmission by the second terminal apparatus on the second time-frequency resource is canceled.

9. The method of claim 8,
wherein the transmission by the second terminal apparatus on the second time-frequency resource is canceled when first-priority service data is to be sent on a part or all of a time domain resource in the second time-frequency resource, and wherein a first priority of the first-priority service data is higher than a second priority of the first uplink data; or
wherein the transmission by the second terminal apparatus on the second time-frequency resource is canceled when a first frequency domain resource used for transmitting the first-priority service data overlaps a second frequency domain resource in the second time-frequency resource, and wherein the first priority of the first-priority service data is higher than the second priority of the first uplink data.

10. The method of claim 1, wherein the first terminal apparatus is a massive machine-type communication (mMTC) apparatus, and wherein the second terminal apparatus is an enhanced mobile broadband (eMBB) apparatus.

11. A first terminal apparatus comprising:
a memory configured to store instructions; and
at least one processor coupled to the memory, wherein when executed by the at least one processor, the instructions cause the first terminal apparatus to:
obtain a first time-frequency resource configured for a second terminal apparatus to transmit first uplink data, wherein the first time-frequency resource is based on first uplink grant information of the second terminal apparatus; and
on a second time-frequency resource, second uplink data,
wherein the second time-frequency resource is a part of the first time-frequency resource.

12. The first terminal apparatus of claim 11, wherein when executed by the at least one processor, the instructions further cause the first terminal apparatus to obtain indication information, and wherein the indication information comprises one or more of:
first information about a quantity of repeated transmissions of the second terminal apparatus;
type information of repeated transmission of the second terminal apparatus;
configuration information of the first time-frequency resource;
frequency hopping type information; or
frequency domain offset information for frequency hopping.

13. The first terminal apparatus of claim 11, wherein the first time-frequency resource comprises resources for the second terminal apparatus to repeatedly transmit the first uplink data, and wherein when executed by the at least one processor, the instructions further cause the first terminal apparatus to:
receive indication information, wherein the indication information comprises one or more of resource index information of the second time-frequency resource or redundancy version (RV) information related to the second time-frequency resource; and
determine, based on the indication information, the second time-frequency resource.

14. The first terminal apparatus of claim 11, wherein when executed by the at least one processor, the instructions further cause the first terminal apparatus to:
randomly select the part of the first time-frequency resource as the second time-frequency resource; or
determine, based on identification information of the first terminal apparatus, the second time-frequency resource.

15. The first terminal apparatus of claim 11, wherein the first time-frequency resource comprises a third time-frequency resource of a first hop and a fourth time-frequency resource of a second hop, wherein a first frequency domain resource in the third time-frequency resource does not overlap a second frequency domain resource in the fourth time-frequency resource, and wherein when executed by the at least one processor, the instructions further cause the first terminal apparatus to:
receive indication information comprising first frequency hopping index information of the first hop or second frequency hopping index information of the second hop; and
determine, based on the indication information, the second time-frequency resource, wherein the second time-frequency resource comprises the third time-frequency resource or the fourth time-frequency resource.

16. The first terminal apparatus of claim 11, wherein the first time-frequency resource comprises a third time-frequency resource of a first hop and a fourth time-frequency resource of a second hop, wherein a first frequency domain resource in the third time-frequency resource does not overlap a second frequency domain resource in the fourth time-frequency resource, and wherein when executed by the at least one processor, the instructions further cause the first terminal apparatus to:
randomly select third time-frequency resource or the fourth time-frequency resource as the second time-frequency resource; or
determine, based on identification information of the first terminal apparatus, the second time-frequency resource, wherein the second time-frequency resource comprises the third time-frequency resource or the fourth time-frequency resource.

17. The first terminal apparatus of claim 11, wherein when executed by the at least one processor, the instructions further cause the first terminal apparatus to send indication information indicating that the second time-frequency resource is being used to send the second uplink data.

18. The first terminal apparatus of claim 11, wherein when executed by the at least one processor, the instructions further cause the first terminal apparatus to cancel sending of the second uplink data on the second time-frequency resource when a first condition is met, and wherein the first condition comprises one or more of the following:
the second time-frequency resource comprises a symbol that is unavailable to the first terminal apparatus; or
transmission by the second terminal apparatus on the second time-frequency resource is canceled.

19. The first terminal apparatus of claim 18,
wherein the transmission by the second terminal apparatus on the second time-frequency resource is canceled when first-priority service data is to be sent on a part or all of a time domain resource in the second time-frequency resource, and wherein a first priority of the first-priority service data is higher than a second priority of the first uplink data; or
wherein the transmission by the second terminal apparatus on the second time-frequency resource is canceled when a first frequency domain resource used for transmitting the first-priority service data overlaps a second frequency domain resource in the second time-frequency resource, and wherein a priority of the first-priority service data is higher than a priority of the first uplink data.

20. A computer program product comprising computer-executable instructions that are stored on a non-transitory computer-readable storage medium and that, when executed by at least one processor, cause a first data transmission apparatus to:
obtain a first time-frequency resource configured for a second terminal apparatus to transmit first uplink data, wherein the first time-frequency resource is based on uplink grant information of the second terminal apparatus; and
send, on a second time-frequency resource, second uplink data, wherein the second time-frequency resource is a part of the first time-frequency resource.
